(19) United States
(12) Patent Application Publication
(10) Pub. No.: US 2025/0150997 A1
(43) Pub. Date: May 8, 2025

(54) SOURCE BASED SYNCHRONIZATION FOR WIRELESS DEVICES

(71) Applicant: QUALCOMM Incorporated, San Diego, CA (US)

(72) Inventors: Hui GUO, Beijing (CN); Tien Viet NGUYEN, Bridgewater, NJ (US); Kapil GULATI, Belle Mead, NJ (US); Shijun WU, San Diego, CA (US); Gabi SARKIS, San Diego, CA (US)

(21) Appl. No.: 18/838,051

(22) PCT Filed: May 5, 2022
(86) PCT No.: PCT/CN2022/090921

§ 371 Date: Aug. 13, 2024

(51) Int. Cl. H04W 56/00

(52) U.S. Cl. CPC H04W 56/0015

(57) ABSTRACT

Methods, systems, and devices for wireless communications are described. A first device may activate an independent synchronization source mode based on one or more conditions associated with the first device. The independent synchronization source mode may correspond to the first device operating as reference for synchronization. The first device may transmit one or more synchronization signals indicating a device type of the first device and indicating that the first device is operating as the reference for synchronization. For example, the first device may select one or more bits or an identifier corresponding to the device type to include in the one or more synchronization signals. A second device receiving the one or more synchronization signals may select the first device as a reference for synchronization based on the device type. The second device may synchronize with the first device using the synchronization signal.

### CROSS REFERENCE

The present Application is a 371 national phase filing of International PCT Application No. PCT/CN2022/090921 by GUO et al., entitled “SOURCE BASED SYNCHRONIZATION FOR WIRELESS DEVICES,” filed May 5, 2022, which is assigned to the assignee hereof, and which is expressly incorporated by reference in its entirety herein.

### FIELD OF TECHNOLOGY

The following relates to wireless communications, including source based synchronization for wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support source based synchronization for wireless devices. For example, the described techniques provide for a first device, acting as an independent synchronization source, to indicate its device type to one or more other devices, where the one or more other devices may synchronize with the first device based on the indicated device type. Additionally, the first device may activate an independent synchronization source mode (e.g., to operate as a reference for synchronization) based on one or more conditions associated with the first device being satisfied. When operating as a reference for synchronization, the first device may transmit a synchronization signal to the one or more other devices. The synchronization signal may indicate the device type associated with the first device and may indicate that the first device is operating as the reference for synchronization. For example, the first device may select one or more bits or an identifier corresponding to the device type to include in the synchronization signal. The first device may be an example of a road-side unit (RSU), on-board unit (OBU), or the like.

A second device (e.g., an OBU, an RSU, or the like), receiving the synchronization signal, may select the first device as a reference for synchronization based on the device type or other factors. Additionally, or alternatively, the synchronization signal may indicate a priority of a data packet to be transmitted by the first device, and the second device may select the first device as a reference for synchronization based on the indicated priority. The second device may synchronize with the first device using the synchronization signal. A method for wireless communications at a first wireless device is described. The method may include activating an independent synchronization source mode for the first wireless device based on one or more conditions associated with the first wireless device being satisfied, where the independent synchronization source mode corresponds to the first wireless device operating as a reference for synchronization and transmitting, by the first wireless device operating in the independent synchronization source mode, one or more synchronization signals indicating a device type associated with the first wireless device and indicating that the first wireless device is operating as the reference for synchronization.

An apparatus for wireless communications at a first wireless device is described. The apparatus may include a processor, memory coupled with the processor, and instructions stored in the memory. The instructions may be executable by the processor to cause the apparatus to activate an independent synchronization source mode for the first wireless device based on one or more conditions associated with the first wireless device being satisfied, where the independent synchronization source mode corresponds to the first wireless device operating as a reference for synchronization and transmit, by the first wireless device operating in the independent synchronization source mode, one or more synchronization signals indicating a device type associated with the first wireless device and indicating that the first wireless device is operating as the reference for synchronization.

Another apparatus for wireless communications at a first wireless device is described. The apparatus may include means for activating an independent synchronization source mode for the first wireless device based on one or more conditions associated with the first wireless device being satisfied, where the independent synchronization source mode corresponds to the first wireless device operating as a reference for synchronization and means for transmitting, by the first wireless device operating in the independent synchronization source mode, one or more synchronization signals indicating a device type associated with the first wireless device and indicating that the first wireless device is operating as the reference for synchronization.

A non-transitory computer-readable medium storing code for wireless communications at a first wireless device is described. The code may include instructions executable by a processor to activate an independent synchronization source mode for the first wireless device based on one or more conditions associated with the first wireless device being satisfied, where the independent synchronization source mode corresponds to the first wireless device operating as a reference for synchronization and transmit, by the first wireless device operating in the independent synchronization source mode, one or more synchronization signals indicating a device type associated with the first wireless device and indicating that the first wireless device is operating as the reference for synchronization.

In some examples of the method, apparatuses, and non-transitory computer-readable medium described herein, transmitting the one or more synchronization signals may include operations, features, means, or instructions for transmitting an indication of a priority of the first wireless device, the priority indicating the first wireless device acting as an independent synchronization source or indicating a priority group associated with the first wireless device.

In some examples of the method, apparatuses, and non-transitory computer-readable medium described herein, the one or more synchronization signals include a bit field indicating a coverage status of the first wireless device and the method, apparatuses, and non-transitory computer-readable medium may include further operations, features, means, or instructions for selecting one or more bits for the bit field indicating the coverage status based on the device type associated with the first wireless device and the independent synchronization source mode, where the one or more bits indicate the device type associated with the first wireless device and indicate that the first wireless device may be operating as the reference for synchronization.

In some examples of the method, apparatuses, and non-transitory computer-readable medium described herein, the one or more synchronization signals include a sidelink master information block (MIB) and the method, apparatuses, and non-transitory computer-readable medium may include further operations, features, means, or instructions for selecting one or more bits for the sidelink MIB based on the device type associated with the first wireless device and the independent synchronization source mode, where the one or more bits indicate the device type associated with the first wireless device and indicate that the first wireless device may be operating as the reference for synchronization.

Some examples of the method, apparatuses, and non-transitory computer-readable medium described herein may further include operations, features, means, or instructions for selecting a first identifier from a set of identifiers associated with the independent synchronization source mode, where the set of identifiers corresponds to the device type associated with the first wireless device and generating the one or more synchronization signals based on the first identifier.

Some examples of the method, apparatuses, and non-transitory computer-readable medium described herein may further include operations, features, means, or instructions for receiving a second one or more synchronization signals indicating a device type associated with a second wireless device and deactivating the independent synchronization source mode for the first wireless device based on receiving the second one or more synchronization signals.

In some examples of the method, apparatuses, and non-transitory computer-readable medium described herein, the device type associated with the first wireless device and the device type associated with the second wireless device may be the same and the method, apparatuses, and non-transitory computer-readable medium may include further operations, features, means, or instructions for receiving, as part of the second one or more synchronization signals, a second identifier corresponding to the device type associated with the second wireless device, where deactivating the independent synchronization source mode for the first wireless device may be based on a comparison of the first identifier and the second identifier.

In some examples of the method, apparatuses, and non-transitory computer-readable medium described herein, the device type associated with the first wireless device may be different from the device type associated with the second wireless device and the method, apparatuses, and non-transitory computer-readable medium may include further operations, features, means, or instructions for receiving, as part of the second one or more synchronization signals, a second identifier corresponding to the device type associated with the second wireless device, where deactivating the independent synchronization source mode for the first wireless device may be based on the device type associated with the second wireless device.

In some examples of the method, apparatuses, and non-transitory computer-readable medium described herein, the one or more conditions associated with the first wireless device may be satisfied based on a deployment scenario of the first wireless device.

In some examples of the method, apparatuses, and non-transitory computer-readable medium described herein, the first wireless device may be an RSU.

Some examples of the method, apparatuses, and non-transitory computer-readable medium described herein may further include operations, features, means, or instructions for determining one or more applications supported by the first wireless device, where the one or more conditions associated with the first wireless device may be satisfied based on the one or more applications.

Some examples of the method, apparatuses, and non-transitory computer-readable medium described herein may further include operations, features, means, or instructions for determining that the one or more conditions associated with the first wireless device may be satisfied based on a priority of a packet for transmission by the first wireless device.

In some examples of the method, apparatuses, and non-transitory computer-readable medium described herein, the one or more synchronization signals include a reserved bit field and the method, apparatuses, and non-transitory computer-readable medium may include further operations, features, means, or instructions for selecting one or more bits for the reserved bit field based on the priority of the packet, where the one or more bits indicate the priority of the packet.

In some examples of the method, apparatuses, and non-transitory computer-readable medium described herein, at least one of the one or more bits indicates a device priority for the packet, the device priority corresponding to one or both of an RSU and an OBU.

Some examples of the method, apparatuses, and non-transitory computer-readable medium described herein may further include operations, features, means, or instructions for monitoring, within a time period, for a second one or more synchronization signals from a second wireless device, where activating the independent synchronization source mode may be based on an absence of the second one or more synchronization signals during the monitoring within the time period.

In some examples of the method, apparatuses, and non-transitory computer-readable medium described herein, the one or more synchronization signals include a sidelink synchronization signal (SLSS).

In some examples of the method, apparatuses, and non-transitory computer-readable medium described herein, a first device type corresponds to an RSU and a second device type corresponds to an OBU.

A method for wireless communications at a second wireless device is described. The method may include receiving, from a first wireless device, one or more synchronization signals indicating a device type associated with the first wireless device and indicating that the first wireless device is operating as a reference for synchronization, selecting the first wireless device as the reference for synchronization based on the one or more synchronization signals and the device type, and synchronizing with the first wireless device based on the selecting.

An apparatus for wireless communications at a second wireless device is described. The apparatus may include a processor, memory coupled with the processor, and instructions stored in the memory. The instructions may be executable by the processor to cause the apparatus to receive, from a first wireless device, one or more synchronization signals indicating a device type associated with the first wireless device and indicating that the first wireless device is operating as a reference for synchronization, select the first wireless device as the reference for synchronization based on the one or more synchronization signals and the device type, and synchronize with the first wireless device based on the selecting.

Another apparatus for wireless communications at a second wireless device is described. The apparatus may include means for receiving, from a first wireless device, one or more synchronization signals indicating a device type associated with the first wireless device and indicating that the first wireless device is operating as a reference for synchronization, means for selecting the first wireless device as the reference for synchronization based on the one or more synchronization signals and the device type, and means for synchronizing with the first wireless device based on the selecting.

A non-transitory computer-readable medium storing code for wireless communications at a second wireless device is described. The code may include instructions executable by a processor to receive, from a first wireless device, one or more synchronization signals indicating a device type associated with the first wireless device and indicating that the first wireless device is operating as a reference for synchronization, select the first wireless device as the reference for synchronization based on the one or more synchronization signals and the device type, and synchronize with the first wireless device based on the selecting.

Some examples of the method, apparatuses, and non-transitory computer-readable medium described herein may further include operations, features, means, or instructions for transmitting one or more synchronization signals indicating that a timing of the second wireless device may be based on the first wireless device being the reference for synchronization for the second wireless device.

Some examples of the method, apparatuses, and non-transitory computer-readable medium described herein may further include operations, features, means, or instructions for receiving, as part of the one or more synchronization signals, a bit field indicating a coverage status of the first wireless device, where one or more bits for the bit field indicate the device type associated with the first wireless device and indicate that the first wireless device may be operating as the reference for synchronization, and where selecting the first wireless device as the reference for synchronization may be based on the one or more bits.

Some examples of the method, apparatuses, and non-transitory computer-readable medium described herein may further include operations, features, means, or instructions for receiving, as part of the one or more synchronization signals, a sidelink MIB, where one or more bits for the sidelink MIB indicate the device type associated with the first wireless device and indicate that the first wireless device may be operating as the reference for synchronization, and where selecting the first wireless device as the reference for synchronization may be based on the one or more bits.

Some examples of the method, apparatuses, and non-transitory computer-readable medium described herein may further include operations, features, means, or instructions for receiving, as part of the one or more synchronization signals, a first identifier from a set of identifiers associated with an independent synchronization source mode, where the set of identifiers corresponds to the device type associated with the first wireless device, and where selecting the first wireless device as the reference for synchronization may be based on the first identifier.

Some examples of the method, apparatuses, and non-transitory computer-readable medium described herein may further include operations, features, means, or instructions for receiving a second one or more synchronization signals indicating a device type associated with a third wireless device and indicating that the third wireless device may be operating as a second reference for synchronization, where the second one or more synchronization signals include a second identifier from the set of identifiers associated with the independent synchronization source mode and corresponding to the device type associated with the third wireless device, where selecting the first wireless device as the reference for synchronization may be based on a comparison of the first identifier and the second identifier.

In some examples of the method, apparatuses, and non-transitory computer-readable medium described herein, the device type associated with the first wireless device and the device type associated with the third wireless device may be the same.

In some examples of the method, apparatuses, and non-transitory computer-readable medium described herein, selecting the first wireless device as the reference for synchronization may include operations, features, means, or instructions for selecting the first wireless device based on a deployment scenario of the second wireless device, one or more applications supported by the second wireless device, or a combination thereof.

Some examples of the method, apparatuses, and non-transitory computer-readable medium described herein may further include operations, features, means, or instructions for selecting the first wireless device as the reference for synchronization may be based on the device type associated with the first wireless device and the device type associated with the second wireless device.

Some examples of the method, apparatuses, and non-transitory computer-readable medium described herein may further include operations, features, means, or instructions for receiving, as part of the one or more synchronization signals, a reserved bit field, where one or more bits for the reserved bit field indicate a priority of a packet for transmission by the first wireless device, and where selecting the first wireless device as the reference for synchronization may be based on the priority of the packet.

In some examples of the method, apparatuses, and non-transitory computer-readable medium described herein, at least one of the one or more bits indicates a device priority for the packet, the device priority corresponding to one or both of an RSU and an OBU and selecting the first wireless device as the reference for synchronization may be based on the device priority.

In some examples of the method, apparatuses, and non-transitory computer-readable medium described herein, the one or more synchronization signals include an SLSS.

In some examples of the method, apparatuses, and non-transitory computer-readable medium described herein, a first device type corresponds to an RSU and a second device type corresponds to an OBU.

### BRIEF DESCRIPTION OF THE DRAWINGS

FIG. 1 illustrates an example of a wireless communications system that supports source based synchronization for wireless devices in accordance with one or more aspects of the present disclosure.

FIG. 2 illustrates an example of a wireless communications system that supports source based synchronization for wireless devices in accordance with one or more aspects of the present disclosure.

FIG. 3 illustrates an example of a synchronization signal coverage that supports source based synchronization for wireless devices in accordance with one or more aspects of the present disclosure.

FIG. 4 illustrates an example of a process flow that supports source based synchronization for wireless devices in accordance with one or more aspects of the present disclosure.

FIGS. 5 and 6 show block diagrams of devices that support source based synchronization for wireless devices in accordance with one or more aspects of the present disclosure.

FIG. 7 shows a block diagram of a communications manager that supports source based synchronization for wireless devices in accordance with one or more aspects of the present disclosure.

FIG. 8 shows a diagram of a system including a device that supports source based synchronization for wireless devices in accordance with one or more aspects of the present disclosure.

FIGS. 9 through 12 show flowcharts illustrating methods that support source based synchronization for wireless devices in accordance with one or more aspects of the present disclosure.

### DETAILED DESCRIPTION

In some wireless communications systems, a user equipment (UE) may receive synchronization signals from a synchronous source (e.g., a synchronization source) to enable the UE to synchronize with the synchronous source prior to establishing a connection and communicating with the synchronous source. For example, the synchronization signals may allow the UE to transmit and receive messages with the synchronous source according to timings as indicated by the synchronization signals (e.g., the UE adjusts timings to align with timings of the synchronous source to enable communications between the UE and the synchronous source or other devices synchronized with the synchronous source). In some cases, the synchronous source may be a network entity such as a base station, a synchronization reference UE, or a similar wireless device that is connected (e.g., directly or indirectly) to a global navigation satellite system (GNSS) or other timing source, where the timings associated with the synchronization signals are determined based on the GNSS.

Alternatively, the synchronous source may be outside of a coverage area for the GNSS and may determine timings to indicate with the synchronization signals without a direct connection to the GNSS. A synchronous source in this scenario may be referred to as an “independent” synchronous source. For example, the synchronous source may belong to a group or cluster and may synchronize communications with other devices (such as the UE) in the group or cluster. In such cases, where the synchronous source is outside the GNSS coverage, the UE may attempt to establish connection with the synchronous source and may receive synchronization signals for the synchronization. In some examples, a synchronous source may use sidelink synchronization signals (SLSSs) for synchronization purposes. The synchronous source may transmit one or more SLSSs to the UE, and the UE may synchronize with the synchronous source based on the one or more SLSSs.

In some cases, the UE may receive multiple synchronization signals (e.g., multiple SLSSs) from respective multiple synchronous sources, and may select a synchronous source with which to synchronize. For example, the UE may prioritize synchronous sources that are directly connected (i.e., directly synchronized) to the GNSS over synchronous sources that are indirectly connected to the GNSS. The UE may further prioritize a synchronous source with any connection (e.g., direct or indirect) to the GNSS over out-of-coverage synchronous sources (e.g., independent synchronous sources). However, in some scenarios, the UE may be unable to differentiate between synchronous sources for selection. Some independent synchronous sources may provide more reliable synchronization or may be more useful to the UE than other independent synchronous sources, for example.

As described herein, the UE may select an independent synchronous source based on a device type associated with the independent synchronous source, a priority of a data packet to be transmitted by the independent synchronous source, a deployment scenario of the UE, one or more applications supported by the UE, or a combination thereof. For example, one or more independent synchronous sources and the UE may each be devices that are part of a vehicle-to-everything (V2X) system, such as a road-side unit (RSU), an on-board unit (OBU), or the like, and may communicate via sidelink communication links. A first independent synchronous source may transmit one or more synchronization signals, such as SLSSs, to the UE and may include, in the synchronization signal(s), an indication of a device type associated with the first independent synchronous source. The indication may be one or more bits included in a sidelink master information block (MIB). Additionally, or alternatively, the indication may be an SLSS identifier (ID) corresponding to the device type. The techniques described herein may also support other types of synchronization information indicated by one or more synchronization signals.

A second independent synchronous source may also transmit one or more SLSSs to the UE that indicate a device type associated with the second independent synchronous source. The UE may select the first independent synchronous source or the second independent synchronous source as a reference for synchronization, for example, based on the corresponding one or more synchronization signals received at the UE. The UE may synchronize with the selected independent synchronous source and may establish communications with the independent synchronous source based on the synchronization.

In some examples, an independent synchronous source may be an example of a device that activates and deactivates an independent synchronization source mode. For example, the device may, initially, not be operating as an independent synchronous source (independent synchronization source mode is deactivated). Upon determining that one or more conditions associated with the independent synchronization source mode are satisfied, the device may determine to activate the independent synchronization source mode and may begin to operate as a reference for synchronization, e.g., by transmitting synchronization signals. Some examples of the one or more conditions may include, but are not limited to, a deployment scenario of the device, one or more applications supported by the device, a priority of a packet to be transmitted by the device, etc. In some cases, the independent synchronous source may deactivate the independent synchronization source mode, for example, if the independent synchronous source receives a synchronization signal from another device.

Aspects of the disclosure are initially described in the context of wireless communications systems. Aspects of the disclosure are illustrated through an additional wireless communications system, a synchronization signal coverage diagram, and process flows. Aspects of the disclosure are further illustrated by and described with reference to apparatus diagrams, system diagrams, and flowcharts that relate to source based synchronization for wireless devices.

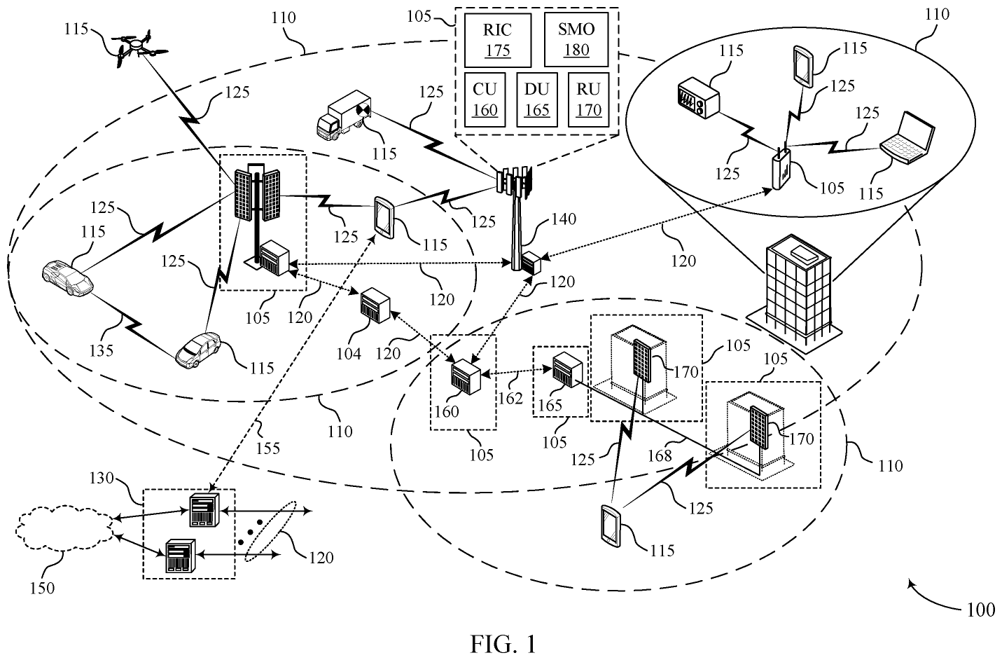

FIG. 1 illustrates an example of a wireless communications system 100 that supports source based synchronization for wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support source based synchronization for wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

A UE 115 attempting to access a wireless network may perform an initial cell search by detecting a primary synchronization signal (PSS) from a network entity 105. The PSS may enable synchronization of slot timing and may indicate a physical layer identity value. The UE 115 may then receive a secondary synchronization signal (SSS). The SSS may enable radio frame synchronization, and may provide a cell identity value, which may be combined with the physical layer identity value to identify the cell. The SSS may also enable detection of a duplexing mode and a cyclic prefix length. Some systems, such as TDD systems, may transmit an SSS but not a PSS. After receiving the PSS and SSS, the UE 115 may receive a master information block (MIB), which may be transmitted in a physical broadcast channel (PBCH). In some cases, the PSS, SSS, and PBCH may be received in a synchronization signal/PBCH block (SSB). The MIB may contain system bandwidth information, an SFN, and a physical channel HARQ indicator channel (PHICH) configuration. After decoding the MIB, the UE 115 may receive one or more system information blocks (SIBs). For example, a first SIB (SIB1) may contain cell access parameters and scheduling information for other SIBs. Decoding SIB1 may enable the UE 115 to receive a second SIB (SIB2). SIB2 may contain RRC configuration information related to random access channel (RACH) procedures, paging, physical uplink control channel (PUCCH), physical uplink shared channel (PUSCH), power control, sounding reference signal (SRS), and cell barring, among other examples.

In some cases, the wireless communication system 100 may include or support networks used for vehicle-based communications, also referred to as V2X, enhanced V2X (eV2X), V2V networks, cellular V2X (C-V2X) networks, or other similar networks. Vehicle-based communication networks may provide always-on telematics where UEs, e.g., vehicle UEs (v-UEs), communicate directly to the network (V2N), to pedestrian UEs (V2P), to infrastructure devices (V21), and to other v-UEs (e.g., via the network and/or directly). The vehicle-based communication networks may support a safe, always-connected driving experience by providing intelligent connectivity where traffic signal/timing, real-time traffic and routing, safety alerts to pedestrians/bicyclist, collision avoidance information, etc., are exchanged.

Wireless communications system 100 may support D2D communications (e.g., including V2X communications). For example, a first UE 115 may communicate with an second UE 115 over sidelink channels. In sidelink communications, the first UE 115 may synchronize with a synchronous source (e.g., the second UE 115) prior to establishing a connection and communicating with the synchronous source (e.g., similar to the synchronization procedures implemented for communications with a network entity 105). Accordingly, for sidelink synchronization, the first UE 115 may receive SLSSs, such as sidelink PSSs (S-PSSs) or sidelink SSSs (S-SSSs), and a physical sidelink broadcast channel (PSBCH), where the S-PSS, S-SSS, and PSBCH are received in a sidelink SSB (S-SSB). In some examples, the S-PSS and the S-SSS may be jointly referred to as an SLSS. In some cases, the PSBCH may additionally be referred to as an SLSS.

In general, synchronization sources for the first UE 115 may include a GNSS, a network entity 105 (e.g., eNB, gNB, or components of a network entity 105), a synchronization reference UE (also referred to as a SyncRef UE), or the like. A baseline synchronous source may include GNSS and network-entity-based synchronization. Additionally, or alternatively, the first UE 115 may include a UE capability that supports an S-SSB based synchronization (e.g., with a SyncRef UE as a source). The first UE 115 may use a data-aided/non-SSB based synchronization mechanism, a synchronous-SSB based synchronization mechanism (e.g., may perform S-SSB search within a time window), or a combination thereof.

In some cases, GNSS-based synchronization alone may not be sufficient or robust for different use cases or scenarios. For example, in V2X communications, the first UE 115 may be an example of a v-UE, such as an OBU, and may experience high mobility (e.g., if the v-UE is driving or otherwise in motion). Some scenarios may introduce difficulty when the first UE 115 attempts to synchronize with the GNSS, such as when the first UE 115 drives through a tunnel, enters a deep parking garage, etc., and a synchronization signal transmitted by a GNSS device may be unreliable. Additionally, or alternatively, a GNSS-based synchronization signals may be unavailable. In such cases, the first UE 115 may receive one or more synchronization signals (e.g., SLSSs) from an independent synchronous source, such as a second UE 115 via a sidelink channel. In some examples, the first UE 115 may receive additional synchronization signals (e.g., SLSSs) from additional independent synchronous sources, e.g., additional UEs 115.

Different synchronous sources may be more suitable than others, depending on context. For example, an RSU may provide increased reliability for synchronization with the first UE 115 in a local area of the RSU. However, if the first UE 115 moves outside of the local area, the RSU may no longer be available as a synchronous source. Alternatively, an OBU may be more mobile than an RSU, which may result in unstable or otherwise inconsistent synchronization, depending on mobility of the first UE 115. However, in some V2X scenarios, the first UE 115 may synchronize with the OBU in order to communicate directly with the OBU, e.g., an RSU may not be sufficient to enable communication between the first UE 115 and the OBU.

In some examples, the first UE 115 may select a synchronous source to use as a reference for synchronization based on a priority scheme. For example, a synchronous source may be associated with a priority value or a priority group. A priority value may indicate a priority of the synchronous source as an independent synchronization source. Multiple priority groups may be defined based on a quantity of hops away from a direct synchronization source, such as a GNSS device. As the quantity of hops away from the GNSS increases, a quality of the synchronization provided by a synchronous source decreases. Accordingly, devices that are directly synchronized to the GNSS may be associated with a relatively higher priority group than devices that are one or more hops away from the GNSS.

According to the techniques described herein, the first UE 115 may select a synchronous source (e.g., an independent synchronous source, which may also be referred to herein as an independent synchronization source) based on a device type of the synchronous source, which may be indicated as part of one or more SLSSs. For example, the synchronous source may select one or more bits to include in a sidelink MIB (SL-MIB) that are associated with the device type. In some examples, the synchronous source may select an SLSS ID included in the SLSS(s) that corresponds to the device type, and the first UE 115 may determine the device type based on the SLSS ID. In some cases, the synchronous source may also indicate, as part of the SLSS, a priority of a packet (e.g., a data packet) for transmission by the synchronous source, and the first UE 115 may select the synchronous source based on the indicated priority.

Additionally, if the first UE 115 receives multiple SLSSs from multiple independent synchronization sources, the first UE 115 may select from among the multiple independent synchronization sources based on the corresponding device types, corresponding priority values or priority groups, a device type of the first UE 115, a deployment scenario of the first UE 115, an indicated packet priority, or the like, among other examples. In any case, the first UE 115 may synchronize with selected synchronous source based on the corresponding received SLSS(s), such that communications between the first UE 115 and the selected synchronous source are aligned in timing.

The techniques described herein also support scenarios in which a synchronous source, such as the second UE 115, may determine to activate or deactivate an independent synchronization source mode, e.g., based on one or more conditions being satisfied. For example, the second UE 115 may activate the independent synchronization source mode based on a deployment scenario of the second UE 115, a packet priority of a packet for transmission by the second UE 115, one or more supported applications of the second UE 115, or a combination thereof, among other examples.

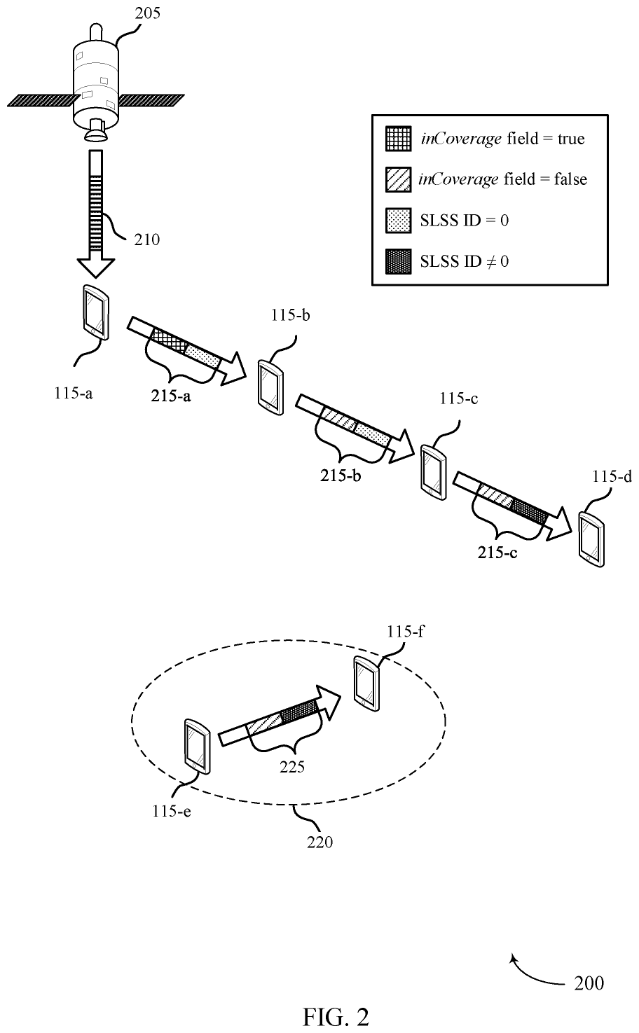

FIG. 2 illustrates an example of a wireless communications system 200 that supports source based synchronization for wireless devices in accordance with one or more aspects of the present disclosure. In some examples, the wireless communications system 200 may implement aspects of wireless communications system 100. The wireless communications system 200 may include UEs 115, which may be examples of UEs 115 as described above with reference to FIG. 1. The wireless communications system 200 may also include a GNSS satellite 205, which may be an example of a GNSS device that operates as a GNSS-based synchronous source. In some examples, the wireless communications system 200 may be an example of a V2X system, such as an LTE V2X system, and the UEs 115 may be examples of OSUs, RSUs, or other V2X devices, or a combination thereof. Additionally, a UE 115 operating as a synchronization source may be referred to as a SyncRef UE.

The wireless communications system 200 may illustrate an example of a synchronization chain, in which UEs 115 may receive synchronization signals (e.g., SLSSs) from other UEs 115 or the GNSS satellite 205. A UE 115 in the wireless communications system 200 may obtain synchronization information (e.g., S-PSS, S-SSS, PSBCH, S-SSB, etc.) to synchronize with the GNSS to support efficient and reliable communications with other devices in the wireless communications system 200. The UE 115 may select a synchronization source from which to obtain synchronization information (e.g., synchronization signals) based on one or more priority groups, which may correspond to a reliability of the synchronization source to operate as a reference for synchronization. For example, a UE 115 may synchronize with the GNSS directly or indirectly. Direct synchronization may refer to synchronization with a GNSS device, such as the GNSS satellite 205, operating as a synchronization source. Indirect synchronization may refer to synchronization with a device that is, in turn, directly synchronized with the GNSS. That is, a device synchronized with the GNSS may act as a synchronization source by propagating GNSS-based synchronization signals to other devices, such that the other devices may synchronize with the GNSS without having a direct connection to a GNSS device.

A synchronization source may be considered as in GNSS coverage if the synchronization source has a direct connection to the GNSS, or is synchronized to a second synchronization source that, in turn, has a direct connection to the GNSS (e.g., if the synchronization source is synchronized to an in-coverage second synchronization source). A synchronization source may be considered as out of GNSS coverage if the synchronization source is synchronized to a second synchronization source that is out of GNSS coverage.

In some cases, a device, such as a SyncRef UE, may operate as an independent synchronization source. Here, an independent synchronization source may synchronize with an internal clock (e.g., its own internal clock), and may transmit synchronization signals that enable other devices to synchronize with the timing of the independent synchronization source. The independent synchronization source may not synchronize with the GNSS and may not rely on the GNSS for timing. Accordingly, independent synchronization sources may be considered as out of GNSS coverage.

Synchronization sources (e.g., devices operating as synchronization sources) may belong to a priority group according to a level of indirect synchronization, e.g., based on a quantity of communication links over which a synchronization signal from a GNSS device may be propagated before reaching a receiving device that performs synchronization using the synchronization signal. Direct synchronization may be associated with increased reliability of synchronization references, and reliability may decrease as the quantity of communication links increases. Accordingly, synchronization sources that provide direct GNSS synchronization (e.g., are in-coverage of the GNSS) may belong to a higher priority group than synchronization sources that provide indirect GNSS synchronization. Further, independent synchronization sources may belong to a lower priority group than synchronization sources that are directly connected to the GNSS.

In the example of FIG. 2, the GNSS satellite 205 and the UEs 115 may be associated with priority groups based on a respective quantity of “hops” from the GNSS in the synchronization chain. The GNSS satellite 205, as the most direct GNSS synchronization source, may belong to a highest priority group, e.g., a priority group 1. The UE 115-a, at the first hop, may belong to a priority group 2, e.g., based on the UE 115-a having a direct connection to the GNSS satellite 205. The UE 115-b may belong to a priority group 3 based on the UE 115-b being at the second hop of the synchronization chain. The UE 115-c and the UE 115-e may both belong to a lowest priority group, e.g., priority group 4. Here, the UE 115-c belongs to the priority group 4 based on the UE 115-c being at the third hop of the synchronization chain, while the UE 115-e belongs to the priority group 4 based on the UE 115-e operating as an independent synchronization source.

A UE 115 may select a synchronization source to use as a reference for synchronization based on a priority (e.g., a priority group) of the synchronization source. Additionally, in accordance with the techniques described herein, the UE 115 may select a synchronization source based on a device type of the synchronization source. For example, a synchronization source, such as an independent synchronization source, may be an RSU, an OBU, or another V2X device. An RSU operating as an independent synchronization source may be more suitable for some synchronization scenarios than an OBU, while an OBU may be an appropriate independent synchronization source in other synchronization scenarios. In some examples, an independent synchronization source may be associated with a priority (e.g., a priority value) that indicates the independent synchronization source acting as a reference for synchronization.

A synchronization signal (e.g., one or more synchronization signals) transmitted by a synchronization source may indicate synchronization information associated with or based on the priority group of the synchronization source, a device type associated with the synchronization source, or the like, among other examples. For example, a SyncRef UE may transmit one or more SLSSs, such as one or more PSSs, SSSs, PSBCHs, or a combination thereof. The one or more SLSSs may include an SLSS ID and an in coverage indicator field (e.g., inCoverage). In some cases, the SLSS ID and inCoverage may be carried on a PSBCH, e.g., within a sidelink MIB or SSB transmission of the SyncRef UE. In some examples, a synchronization signal may be generated based on the selected SLSS ID. In some cases, synchronization signals may additionally indicate a type of synchronization, such as a GNSS based synchronization (e.g., typeSync=GNSS), a subframe resource to transmit/receive the synchronization signals (e.g., either a first or second resource in the subframe, such as a resource-1 or a resource-2), or the like, among other examples.

For a SyncRef UE that is synchronized (e.g., directly or indirectly) to the GNSS, the value of the inCoverage bit field may indicate whether the SyncRef UE is within GNSS coverage (or, in some cases, within coverage of a network entity). For example, inCoverage=0 (e.g., inCoverage=false) may indicate that the SyncRef UE is not in coverage of GNSS, while inCoverage=1 (e.g., inCoverage=true) may indicate that the SyncRef UE is in coverage of GNSS.

A SyncRef UE that is an independent synchronization source may always be considered as out of GNSS coverage (e.g., inCoverage=false). Accordingly, an independent synchronization source may repurpose the inCoverage bit field to indicate the device type of the independent synchronization source. For example, a first value of the inCoverage bit field (e.g., inCoverage=1 or inCoverage=true) may correspond to a first device type, such as an RSU, while a second value of the inCoverage bit field (e.g., inCoverage=0 or inCoverage=false) may correspond to a second device type, such as an OBU. The independent synchronization source may select a bit for the inCoverage bit field of an SLSS that corresponds to the device type of the independent synchronization source.

The SLSS ID may indicate a synchronization source of the SyncRef UE. For example, some SLSS IDs may be reserved for SyncRef UEs that are in GNSS coverage. An SLSS ID=0 may be used by a SyncRef UE that is synchronized to GNSS or to another SyncRef UE that is itself synchronized to GNSS. Other SLSS IDs may be reserved for SyncRef UEs that are out of GNSS coverage, and still other SLSS IDs may be reserved for independent synchronization sources. Additionally, the SLSS IDs reserved for independent synchronization sources may also be used to indicate a device type of the independent synchronization source.

For example, a SyncRef UE that is in coverage of the GNSS satellite 205 may select an SLSS ID randomly from a first set of IDs (e.g., 0 to 167) used for synchronization sources that are in GNSS coverage. A SyncRef UE that is out of coverage of the GNSS satellite 205 may select an SLSS ID randomly from a second set of IDs used for synchronization sources that are out of GNSS coverage. Additionally, or alternatively, a SyncRef UE that is an independent synchronization source may select an SLSS ID randomly from a subset of SLSS IDs (e.g., 170 to 335) that corresponds to the device type associated with the SyncRef UE. For example, a first subset of SLSS IDs (e.g., 170 to 252) may be reserved for RSUs and a second subset of SLSS IDs (e.g., 253 to 335) may be reserved for OBUs. An RSU acting as an independent synchronization source may select an SLSS ID randomly from the first subset, while an OBU acting as an independent synchronization source may select an SLSS ID randomly from the second subset.

In some cases, a SyncRef UE operating as an independent synchronization source may indicate a device type of the SyncRef UE via one or more reserved bits of a sidelink MIB associated with the SLSS. For example, the sidelink MIB may include a bit field for a quantity of reserved bits (e.g., 27) that the SyncRef UE may use to indicate the device type. A first value of one or more of the reserved bits may correspond to an RSU, a second value may correspond to an OBU, and so on. In some examples, the first value and the second value to be used for the corresponding device types may be indicated (e.g., to the SyncRef UE) in a system information block (SIB), may be RRC-configured, or may be preconfigured.

A receiving device may select a synchronization source based on indications included in a synchronization signal from the synchronization source. For example, when the synchronization source is synchronized to the GNSS, a UE 115 receiving a synchronization signal from the synchronization source may determine a priority (e.g., a priority level, a priority group) of the synchronization source based on the SLSS ID and inCoverage. In some examples, the synchronization source may additionally, or alternatively, transmit an indication of the priority to the UE 115. The UE 115 may select the synchronization source as a reference for synchronization based on the determined priority. For example, the UE 115 may receive multiple synchronization signals from multiple synchronization sources, and may select a synchronization source having a highest priority as indicated by the corresponding synchronization signal.

When the synchronization source is an independent synchronization source, a UE 115 receiving the synchronization signal may determine a device type of the independent synchronization source based on the SLSS ID, the value of inCoverage, the value of the one or more reserved bits, a priority indicating the independent synchronization source acting as an independent synchronization source, or a combination thereof. For example, the UE 115 may receive multiple synchronization signals from multiple independent synchronization sources, and may differentiate between the independent synchronization sources based on the corresponding indicated device types. The UE 115 may select an independent synchronization source as a reference for synchronization based on the device type, e.g., based on the indication(s) of the device type.

In the example of FIG. 2, the wireless communications system 200 may include UEs 115 that are synchronized to the GNSS and UEs 115 that are operating as or synchronized to an independent synchronization source. For example, the UE 115-a may be capable of directly communicating with the GNSS satellite 205, e.g., may be in-GNSS coverage. The GNSS satellite 205 may thus belong to a priority group 1, as the GNSS satellite 205 provides a direct source for synchronization with the GNSS. As such, the UE 115-a may prioritize selecting the GNSS satellite 205, when available, over other indirect synchronization sources (such as other UEs 115 belonging to other priority groups). For example, the UE 115-a may select the GNSS satellite 205 as a synchronization source and may synchronize directly with the GNSS by receiving a synchronization signal 210 from the GNSS satellite 205.

The UE 115-a may become a synchronization reference (e.g., SyncRef UE) for additional UEs 115. The UE 115-a, as the first hop in the synchronization chain, may belong to priority group 2. Here, the synchronization signal 215-a transmitted by the UE 115-a may include inCoverage=true (e.g., inCoverage=1) and SLSS ID=0, indicating that the UE 115-a is in coverage of the GNSS satellite 205 (e.g., inCoverage=1) and is directly synchronized to the GNSS satellite 205 (e.g., SLSS ID=0). A UE 115, such as the UE 115-b, may select the UE 115-a as a reference for synchronization (e.g., a synchronization source) when a connection to the GNSS satellite 205 is unavailable based on the UE 115-a having a direct connection to the GNSS satellite 205. For example, the UE 115-b may receive a synchronization signal 215-a from the UE 115-a and may determine that the UE 115-a is associated with priority group 2 based on inCoverage=true and SLSS ID=0. The UE 115-b may synchronize and communicate with the UE 115-a based on the synchronization signal 215-a.

The UE 115-b may also become a reference for synchronization (e.g., SyncRef UE) for additional UEs 115, such as the UE 115-c. The UE 115-b may be located at the second hop of the synchronization chain, where a synchronization signal from the GNSS satellite 205 may be propagated to the UE 115-b via two communication links (e.g., as the synchronization signal 210 and the synchronization signal 215-a). Accordingly, the UE 115-b may belong to priority group 3, and the synchronization signal 215-b may indicate inCoverage=false (e.g., inCoverage=0) and SLSS ID=0. The UE 115-c may receive the synchronization signal 215-b and may synchronize and communicate with the UE 115-b. Additionally, the UE 115-c may also become a SyncRef UE for the UE 115-d and any other UEs 115. That is, the UE 115-c may transmit a synchronization signal 215-c based on GNSS timings from the UE 115-a relayed through the UE 115-b. Based on the location of the UE 115-c in the synchronization chain, e.g., at the third hop, the UE 115-c may belong to priority group 4, and synchronization signal 215-c may indicate inCoverage=false (e.g., inCoverage=0). Additionally, the synchronization signal 215-c may indicate an SLSS ID corresponding to an out-of-coverage SyncRef UE. The UE 115-d may synchronize with the UE 115-c based on the synchronization signal 215-c.

In the example of FIG. 2, the UEs 115-e and 115-f may belong to a group 220, which may also be referred to as a cluster. A cluster may form for a synchronization source based on different UEs connecting to a same synchronization source via SLSSs transmitted by the synchronization source. Additionally, or alternatively, a UE may join a cluster based on a deployment scenario, the synchronization source, or the like. For example, vehicle UEs in close proximity to one another may form a cluster to communicate with other vehicle UEs in the cluster, and synchronizing with a same synchronization source may enable communication amongst the vehicle UEs.

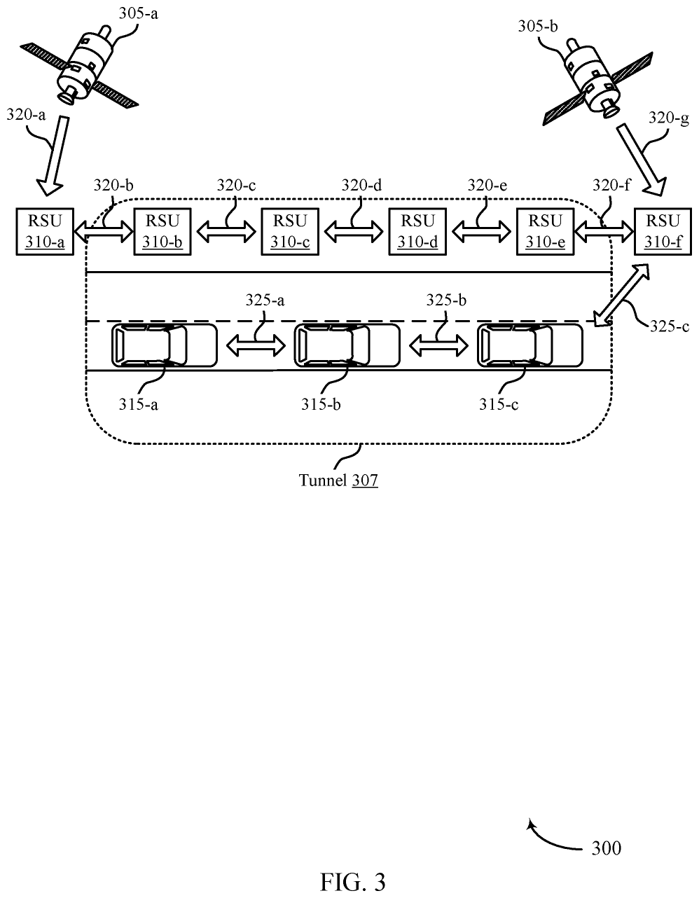

The UE 115-e may be an example of a SyncRef UE acting as an independent synchronization source, e.g., in accordance with an independent synchronization source mode. As described in more detail with reference to FIG. 3, the UE 115-e may determine to operate as an independent synchronization source based on a deployment scenario of the UE 115-e, a priority of a data packet to be transmitted by the UE 115-e, one or more applications supported by the UE 115-e, or the like. Additionally, or alternatively, the UE 115-e may become an independent synchronization source when the GNSS satellite 205 (e.g., direct or indirect synchronization signals from the GNSS) is unobtainable or unavailable. For example, some V2X scenarios, such as communication between the UEs 115-e and 115-f in the group 220, may not require GNSS synchronization. For instance, groupcast or unicast transmissions between the UEs 115-e and 115-f may be successful as long as the UEs 115-e and 115-f are synchronized with one another.

As an independent synchronization source, the UE 115-e may belong to priority group 4. A priority group 4 may correspond to UEs 115 that are acting as independent synchronization sources and to UEs 115 that are synchronized with an independent synchronization source. For example, a UE 115, such as the UE 115-e, acting as an independent synchronization source may be synchronized with its own internal clock and may belong to priority group 4. Additionally, the UE 115-f may be an example of a UE 115 that is synchronized to the UE 115-e that is, in turn, synchronized to its own internal clock. That is, the UE 115-e may not be synchronized with the GNSS satellite 205 and may be considered out of GNSS coverage; the UE 115-e also may not receive synchronization signals 215 from any of the UEs 115-a, 115-b, 115-c, or 115-d. The UE 115-e may transmit a synchronization signal 225 to the UE 115-f that indicates that the UE 115-e is operating as an independent synchronization source and indicates a device type associated with the UE 115-e. For example, the UE 115-e may be an example of an RSU, and may indicate a device type of RSU via a value of a bit in the inCoverage bit field corresponding to an RSU, an SLSS ID reserved for RSUs, or one or more reserved bits with values associated with an RSU, or a combination thereof.

The UE 115-f may receive the synchronization signal 225 and may identify or otherwise determine the device type of the UE 115-e. The UE 115-f may select the UE 115-e as a reference for synchronization based on the synchronization signal 225, the device type, a deployment scenario of the UE 115-f, one or more applications supported by the UE 115-f, or a combination thereof, among other examples. For example, an RSU may be a stationary device and may be confined or otherwise limited to a localized area, but may provide more reliable or consistent synchronization than an OBU, which may be mobile. Additionally, an RSU operating as an independent synchronization source may enable synchronization even in scenarios with increased latency or communications delay. Accordingly, in some cases, the UE 115-f may select the UE 115-e based on the UE 115-e being an RSU.

However, an OBU may be more suitable as an independent synchronization source in some situations. For example, if the UE 115-f is an RSU and the UE 115-e is an OBU, synchronizing with the UE 115-e may enable the UE 115-f to extend its localized coverage area as the UE 115-e moves away from the UE 115-f. Alternatively, if both the UE 115-e and the UE 115-f are OBUs, and the UE 115-e is an OBU that the UE 115-f is attempting to communicate with as part of a cluster or other group scenario (e.g., to enable localized communication between a group of UEs 115), the UE 115-f may select the UE 115-e based on the UE 115-e being an OBU.

Alternatively, in some examples, the UE 115-f may refrain from selecting the UE 115-e as a reference for synchronization based on the device type, a deployment scenario of the UE 115-f, one or more applications supported by the UE 115-f, etc. For example, if the UE 115-f may not remain in the localized area for which the UE 115-e, as an RSU, provides coverage, the UE 115-f may not select the UE 115-e. Similarly, if the UE 115-f is an RSU, the UE 115-f may refrain from selecting OBUs as synchronization sources, and may not select the UE 115-e if the UE 115-e is an OBU.

In any case, based on selecting the UE 115-e as an independent synchronization source, the UE 115-f may synchronize with the UE 115-e using the synchronization signal 225. After synchronization, the UE 115-f and the UE 115-e may establish a communication link, such as a sidelink communication link, over which to communicate.

In some examples, the UE 115-f may act as a SyncRef UE for one or more other UEs 115 based on synchronizing with the UE 115-e. For example, the UE 115-f may transmit one or more synchronization signals that indicate that a timing of the UE 115-f is based on the UE 115-e being a reference for synchronization for the UE 115-f. Put another way, the UE 115-f may transmit one or more synchronization signals that indicate that the UE 115-f is synchronized with an independent synchronization source (e.g., the UE 115-e).

FIG. 3 illustrates an example of a synchronization signal coverage 300 that supports source based synchronization for wireless devices in accordance with one or more aspects of the present disclosure. In some examples, synchronization signal coverage 300 may implement aspects of wireless communications systems 100 and/or 200. For example, synchronization signal coverage 300 may illustrate an example deployment scenario for various types of vehicle UEs, such as RSUs 310 and OBUs 315, which may synchronize with an independent synchronization source or a satellite 305 as described with reference to FIG. 2.

In the example of FIG. 3, the RSUs 310 may be stationary devices distributed along a tunnel 307, such that RSUs 310-a and 310-f are located outside of the tunnel 307 at either end, while RSUs 310-b, 310-c, 310-d, and 310-e may be located within the tunnel 307. Based on the locations of the RSUs 310, the RSUs 310-a and 310-f may have a direct connection to the satellites 305-a and 305-b, respectively, while the RSUs 310-b, 310-c, 310-d, and 310-e may be unable to communicate directly with the satellites 305. The RSU 310-a may receive a synchronization signal 320-a from the satellite 305-a and may synchronize with the satellite 305-a. The RSU 310-f may receive a synchronization signal 320-g from the satellite 305-b for synchronization with the satellite 305-b. The RSUs 310 within the tunnel 307 may rely on the RSU 310-a and/or the RSU 310-f to receive synchronization signals 320-b, 320-c, 320-d, and 320-e. For example, the RSU 310-a, the RSU 310-f, or both, may relay one or more synchronization signals 320 to the RSUs 310 within the tunnel 307, such that the RSUs 310 within the tunnel 307 may indirectly synchronize with the satellite 305-a or the satellite 305-b.

The OBUs 315-a, 315-b, and 315-c may be examples of mobile vehicle UEs driving through the tunnel 307. In some examples, the OBUs 315 may be in a platoon and may exchange data periodically to enable dynamic management and functioning of the OBUs 315 in the platoon. For example, the OBUs 315 may communicate to determine positioning of each OBU 315 and coordinate maneuvers. To facilitate such operations, the OBUs 315 may synchronize with one another via synchronization signals 325-a and 325-b, so that timing of communications between the OBUs 315 has a high reliability (e.g., a reliability above a threshold) and low latency (e.g., a latency target below a threshold).

FIG. 3 may illustrate various scenarios in which a UE, such as an RSU 310 or an OBU 315, may activate an independent synchronization source mode to operate as an independent synchronization source. Additionally, an independent synchronization source in the example of FIG. 3 may support the use of SLSSs for synchronization between UEs, particularly when a GNSS connection is unavailable or unreliable. A UE receiving an SLSS from one or more independent synchronization source modes may select an independent synchronization source as a reference for synchronization based on a device type of (e.g., associated with) the independent synchronization source, a device type of the UE receiving the SLSS, or a combination thereof, among other examples.

For example, activation of the independent synchronization source mode by a UE may rely on satisfaction of one or more conditions associated with the UE, which may, in turn, depend on a device type of the UE. That is, an RSU 310 may activate an independent synchronization source mode in different scenarios or based on different conditions than an OBU 315. Further, a UE may deactivate the independent synchronization source mode based on whether one or more other UEs, associated with respective device types, are operating as independent synchronization sources.

An OBU 315 may activate an independent synchronization source mode based on one or more supported applications of the OBU 315. In the example of FIG. 3, the platooning OBUs 315 may form a cluster (e.g., a local synchronization cluster) and may communicate via groupcast. The OBUs 315 may support one or more applications associated with platooning and based on the cluster. A leading OBU 315, such as the OBU 315-c, may activate the independent synchronization source mode based on determining that the one or more applications satisfy one or more conditions associated with the OBU 315-c. The OBU 315-c may transmit a synchronization signal 325-b to the OBU 315-b. The synchronization signal 325-b may indicate a device type (e.g., OBU) associated with the OBU 315-c and may indicate that the OBU 315-c is operating as a reference for synchronization.

For example, as described with reference to FIG. 2, the OBU 315-c may select, for the synchronization signal 325-b, one or more bits for a sidelink MIB, such as one or more reserved bits, or one or more bits for a bit field indicating a coverage status (e.g., inCoverage), based on the device type. Additionally, or alternatively, the OBU 315-c may select a first identifier from a set of identifiers (e.g., SLSS IDs) associated with the independent synchronization source mode and corresponding to the device type. In some examples, the first set of identifiers associated with independent synchronization sources (e.g., outside of coverage of the GNSS) may be divided into subsets of identifiers, where each subset may correspond to a device type. Here, the OBU 315-c may select the first identifier from the subset corresponding to OBUs. The OBU 315-b, upon reception of the synchronization signal 325-b, may select the OBU 315-c as a reference for synchronization based on the synchronization signal 325-b and the device type of the OBU 315-c.

In another example, the OBU 315-c may activate the independent synchronization source mode if the OBU 315-c has important data (e.g., a high-priority packet) to transmit to another device. For example, the OBU 315-c may be an example of an emergency vehicle, or of a vehicle in an emergency, and may become an independent synchronization source accordingly. The OBU 315-c may determine that one or more conditions associated with the OBU 315-c are satisfied based on a priority of a packet for transmission by the OBU 315-c. In such examples, the OBU 315-c may indicate a priority of the packet in a synchronization signal 325 (e.g., synchronization signal 325-b or 325-c). In some cases, the synchronization signal 325 (e.g., synchronization signal 325-b or 325-c) may further indicate a priority of the packet to be received by another UE, e.g., based on a device type of a receiving UE. For example, if the packet relates to maneuvers to be performed by the OBU 315-c on a roadway in the tunnel 307, the packet may have a relatively higher priority associated with reception by other OBUs 315 on the roadway (e.g., so the other OBUs 315 may avoid the OBU 315-c), and may have a relatively lower priority associated with reception by RSUs 310 located within the tunnel 307 (e.g., as an RSU 310 may be stationary). Further, the packet may have an even lower relative priority associated with reception by RSUs 310 outside of the tunnel 307, as maneuvers performed by the OBU 315-c within the tunnel 307 may be irrelevant to RSUs 310 outside of the tunnel 307.

An OBU 315, an RSU 310, or both, may select the OBU 315-c as an independent synchronization source when the OBU 315-c has a high-priority packet to be transmitted, e.g., based on an indication of the packet priority in a synchronization signal 325 (e.g., synchronization signal 325-b or 325-c) transmitted by the OBU 315-c. Synchronizing with the OBU 315-c may enable an OBU 315, an RSU 310, or both, to receive the high-priority packet.

In some cases, an OBU 315 may activate the independent synchronization source mode based on whether one or more other devices (e.g., associated with respective device types) are also operating as independent synchronization sources. For example, the OBU 315-c may determine or otherwise select a time window with a random duration in which to monitor for other synchronization signals. If the OBU 315-c does not detect any synchronization signals from any other synchronization sources during the time window, the OBU 315-c may activate the independent synchronization source mode. However, if the OBU 315-c receives a synchronization signal, such as a synchronization signal 325-c, the OBU 315-c may refrain from activating the independent synchronization source mode in order to avoid collisions or congestion caused by several independent synchronization sources operating at once.

Additionally, an OBU 315 operating as an independent synchronization source may deactivate the independent synchronization source mode based on detecting a synchronization signal from another independent synchronization source. In some cases, the OBU 315 may deactivate the independent synchronization source mode based on a device type associated with the other independent synchronization source, the device type of the OBU 315, or the like, among other examples. For example, after the OBU 315-c has activated the independent synchronization source mode, the OBU 315-c may receive the synchronization signal 325-c from the RSU 310-f. The synchronization signal 325-c may indicate a device type (e.g., RSU) associated with the RSU 310-f in accordance with the techniques described herein. Based on the RSU 310-f being associated with an RSU device type, the OBU 315-c may deactivate the independent synchronization source mode. That is, an RSU may generally be associated with a relatively higher reliability as a reference for synchronization, or, in the example of FIG. 3, the RSU 310-f may be directly synchronized to the satellite 305-b, which may provide improved accuracy for synchronization.

In some cases, an OBU 315, such as the OBU 315-c, operating as an independent synchronization source, may receive a synchronization signal from a device associated with a device type that is the same as the OBU 315-c, e.g., from another OBU 315. For instance, the OBU 315-c may receive a synchronization signal 325-b from the OBU 315-b. In such cases, the OBU 315-c may determine whether to deactivate the independent synchronization source mode by applying a rule, which may be based on SLSS IDs. As a non-limiting example, the OBU 315-c may compare the SLSS ID of the OBU 315-c with an SLSS ID associated with the OBU 315-b, e.g., indicated by the synchronization signal 325-b. The rule may prioritize smaller or greater values of SLSS IDs. For example, the OBU 315 associated with a relatively greater value of an SLSS ID may be the preferred independent synchronization source, e.g., OBUs 315 with greater SLSS ID values may be prioritized by other OBUs 315 based on the rule. If the OBU 315-c determines that the SLSS ID of the OBU 315-b is greater than the SLSS ID of the OBU 315-c, the OBU 315-c may deactivate the independent synchronization source mode. If, in contrast, the OBU 315-c determines that the SLSS ID of the OBU 315-b is less than the SLSS ID of the OBU 315-c, the OBU 315-c may maintain the independent synchronization source mode (e.g., may not deactivate the independent synchronization source mode). Other examples of rules or combinations of rules may be applied to support determining whether an OBU 315 deactivates the independent synchronization source mode.

In some examples, a similar rule may be applied for a receiving OBU 315 to select an independent synchronization source, e.g., based on receiving synchronization signals. For instance, when a receiving OBU 315 receives multiple synchronization signals (e.g., synchronization signals 325) from multiple independent synchronization sources having a same device type, the OBU 315 may prioritize or otherwise differentiate between the multiple independent synchronization sources based on the rule. In the example of FIG. 3, the OBU 315-b (e.g., while not operating as an independent synchronization source) may receive a synchronization signal 325-b from the OBU 315-c (e.g., operating as an independent synchronization source) and a synchronization signal 325-a from the OBU 315-a (e.g., operating as an independent synchronization source). The OBU 315-b may compare a value of an SLSS ID associated with the OBU 315-a (e.g., indicated in the synchronization signal 325-a) with a value of an SLSS ID associated with the OBU 315-c (e.g., indicated in the synchronization signal 325-c). The SLSS ID associated with the OBU 315-c may have a greater value than the SLSS ID associated with the OBU 315-a. The OBU 315-b may select the OBU 315-c as a reference for synchronization based on the comparison and in accordance with the rule. The OBU 315-b may apply the same procedure (e.g., a comparison and a rule) if the OBU 315-b receives multiple synchronization signals from multiple RSUs 310, e.g., to select an RSU 310 as a reference for synchronization.

An RSU 310 may be associated with one or more conditions for determining whether to activate an independent synchronization source mode that may be the same as or different than the one or more conditions associated with an OBU 315. For example, an RSU 310 may activate an independent synchronization source mode based on one or more supported applications of the RSU 310. In the example of FIG. 3, the RSUs 310 within the tunnel 307 may support a different set of applications than the RSUs 310 outside of the tunnel 307. The applications supported by the RSUs 310 within the tunnel 307 may not satisfy the one or more conditions, while the applications supported by the RSUs 310 outside of the tunnel 307 may satisfy the one or more conditions. Accordingly, the RSU 310-f, for example, may activate the independent synchronization source mode based on determining that the one or more applications satisfy one or more conditions associated with the RSU 310-f. The RSU 310-f may transmit a synchronization signal 325-c to the OBU 315-c, a synchronization signal 320-f to the RSU 310-e, or both, based on activating the independent synchronization source mode. The synchronization signal 325-c and the synchronization signal 320-f may indicate a device type (e.g., RSU) associated with the RSU 310-f and may indicate that the RSU 310-f is operating as a reference for synchronization.

For example, as described with reference to FIG. 2, the RSU 310-f may select, for the synchronization signal 325-c and the synchronization signal 320-f, one or more bits for a sidelink MIB, such as one or more reserved bits, or one or more bits for a bit field indicating a coverage status (e.g., inCoverage), based on the device type (e.g., RSU). Additionally, or alternatively, the RSU 310-f may select a first identifier from a set of identifiers (e.g., SLSS IDs) associated with the independent synchronization source mode and corresponding to the device type. In some examples, the first set of identifiers associated with independent synchronization sources (e.g., outside of coverage of the GNSS) may be divided into subsets of identifiers, where each subset may correspond to a device type. Here, the RSU 310-f may select the first identifier from the subset corresponding to RSUs. The OBU 315-c, upon reception of the synchronization signal 325-c, may select the RSU 310-f as a reference for synchronization based on the synchronization signal 325-c and the device type of the RSU 310-f. Additionally, or alternatively, the RSU 310-e may select the RSU 310-f as a reference for synchronization based on the synchronization signal 320-f and the device type of the RSU 310-f.

In another example, the RSU 310-f may activate the independent synchronization source mode if the RSU 310-f has important data (e.g., a high-priority packet) to transmit to another device. For example, the RSU 310-f may be an example of an emergency device or may have information related to an emergency to transmit to other devices, and may become an independent synchronization source accordingly. The RSU 310-f may determine that one or more conditions associated with the RSU 310-f are satisfied based on a priority of a packet for transmission by the RSU 310-f. In such examples, the RSU 310-f may indicate a priority of the packet in a synchronization signal 320 or a synchronization signal 325. In some cases, the synchronization signal 320 or the synchronization signal 325 may further indicate a device priority of the packet to be received by another UE, e.g., corresponding to a device type (RSU, OBU, etc.) of a receiving UE.

An OBU 315, an RSU 310, or both, may select the RSU 310-f as an independent synchronization source when the RSU 310-f has a high-priority packet to be transmitted, e.g., based on an indication of the packet priority and/or the device priority for the packet in the synchronization signal 320 or the synchronization signal 325 transmitted by the RSU 310-f. Synchronizing with the RSU 310-f may enable an OBU 315, an RSU 310, or both, to receive the high-priority packet.

An RSU 310 may activate the independent synchronization source mode based on a deployment scenario of the RSU 310. Some deployment scenarios may provide more reliable or accurate references for synchronization than other deployment scenarios. For example, an RSU 310 that is deployed within the tunnel 307 may not become an independent synchronization source, because indirect synchronization to the satellite 305-a or the satellite 305-b via other RSUs 310 may support improved performance compared to an RSU 310 acting as an independent synchronization source. As another example, an RSU 310 may be deployed in a parking garage, and may activate the independent synchronization source mode to provide localized synchronization to OBUs 315. Here, the OBUs 315 located within the parking garage may synchronize with the RSU 310 to support communication with other local OBUs 315 and, in some cases (e.g., for underground or large parking garages), may be unable to access GNSS-based synchronization signals.

An RSU 310 may activate the independent synchronization source mode based on whether one or more other devices (e.g., associated with respective device types) are also operating as independent synchronization sources. In the example of FIG. 3, the RSU 310-f may receive the synchronization signal 320-f from the RSU 310-e and may receive the synchronization signal 325-c from the OBU 315-c. The RSU 310-f may refrain from activating the independent synchronization source mode based on detecting one or both of the synchronization signals 320-f and 325-c, e.g., to avoid congestion associated with multiple devices operating as independent synchronization sources. In some examples, the RSU 310-f may refrain from activating the independent synchronization source mode based on a device type of an independent synchronization source associated with a synchronization signal, e.g., based on an indication of the device type in the synchronization signal. For example, the RSU 310-f may refrain from activating the independent synchronization source based on the synchronization signal 320-f indicating a device type associated with the RSU 310-e, e.g., based on receiving a synchronization signal from another RSU, but may proceed with activating the independent synchronization source mode if the RSU 310-f receives a synchronization signal from an OBU.

In some cases, an RSU 310, such as the RSU 310-f, that has activated the independent synchronization source mode may determine to deactivate the independent synchronization source mode based on receiving a synchronization signal from a device associated with a device type that is the same as the RSU 310-f, e.g., from another RSU 310. For instance, the RSU 310-f may receive the synchronization signal 320-f from the RSU 310-e. In such cases, the RSU 310-f may determine whether to deactivate the independent synchronization source mode by applying a rule, which may be based on SLSS IDs. As a non-limiting example, the RSU 310-f may compare the SLSS ID of the RSU 310-f with an SLSS ID associated with the RSU 310-e, e.g., indicated by the synchronization signal 320-f. The rule may prioritize smaller or greater values of SLSS IDs. For example, the RSU 310 associated with a relatively greater value of an SLSS ID may be the preferred independent synchronization source, e.g., RSUs 310 with greater SLSS ID values may be prioritized by other RSUs 310 based on the rule. If the RSU 310-f determines that the SLSS ID of the RSU 310-e is greater than the SLSS ID of the RSU 310-f, the RSU 310-f may deactivate the independent synchronization source mode. If, in contrast, the RSU 310-f determines that the SLSS ID of the RSU 310-e is less than the SLSS ID of the RSU 310-f, the RSU 310-f may maintain the independent synchronization source mode (e.g., may not deactivate the independent synchronization source mode). Other examples of rules or combinations of rules may be applied to support determining whether an RSU 310 deactivates the independent synchronization source mode.

In some examples, a similar rule may be applied for a receiving RSU 310 to select an independent synchronization source as a reference for synchronization, e.g., based on receiving synchronization signals. For instance, when a receiving RSU 310 receives multiple synchronization signals (e.g., synchronization signals 320) from multiple independent synchronization sources having a same device type, the RSU 310 may prioritize or otherwise differentiate between the multiple independent synchronization sources based on the rule. In the example of FIG. 3, the RSU 310-e (e.g., while not operating as an independent synchronization source) may receive a synchronization signal 320-f from the RSU 310-f (e.g., operating as an independent synchronization source) and a synchronization signal 320-e from the RSU 310-d (e.g., operating as an independent synchronization source). The RSU 310-e may compare a value of an SLSS ID associated with the RSU 310-f (e.g., indicated in the synchronization signal 320-f) with a value of an SLSS ID associated with the RSU 310-d (e.g., indicated in the synchronization signal 320-e). The SLSS ID associated with the RSU 310-f may have a greater value than the SLSS ID associated with the RSU 310-d. The RSU 310-e may select the RSU 310-f as a reference for synchronization based on the comparison and in accordance with the rule.

In general, a UE, such as an OBU 315 or an RSU 310, receiving a synchronization signal from an independent synchronization source may select the independent synchronization source as a reference for synchronization based on a device type of the independent synchronization source. For example, in general, a UE may prioritize selection of RSUs (such as an RSU 310) over selection of OBUs (such as OBUs 315) as a synchronization reference. Additionally, while an OBU 315 may select an RSU 310 or another OBU 315 as an independent synchronization source, an RSU 310 may only select another RSU 310, and may not select an OBU 315, as an independent synchronization source. However, any rule or prioritization may be overcome by a priority of a packet to be transmitted by an independent synchronization source. That is, an RSU 310, an OBU 315, or both, may select an independent synchronization source if a synchronization signal transmitted by the independent synchronization source indicates a sufficiently high priority (e.g., such that the priority satisfies a threshold) of a packet for transmission by the independent synchronization source, regardless of a device type associated with the independent synchronization source.

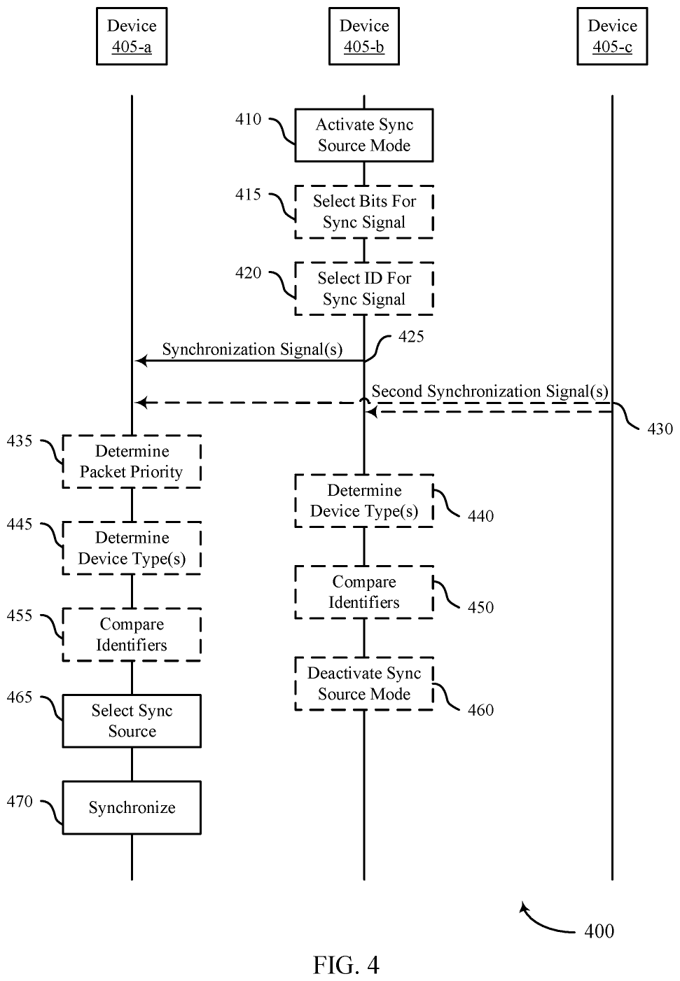

FIG. 4 illustrates an example of a process flow 400 that supports source based synchronization for wireless devices in accordance with one or more aspects of the present disclosure. In some examples, process flow 400 may implement aspects of wireless communications systems 100 and/or 200. Process flow 400 may include a device 405-a, a device 405-b, and a device 405-c, which may be examples of UEs as described herein with reference to FIGS. 1-3. For example, the device 405-a, the device 405-b, and the device 405-c may each be associated with a respective device type, such as an RSU, an OBU, or the like, among other example devices (e.g., V2X devices). As described herein, the device 405-a may be attempting to synchronize and communicate with an independent synchronization source in a wireless communications system, such as a V2X system. The devices 405-b and 405-c may be examples of independent synchronization sources and may transmit one or more synchronization signals to the device 405-a.

In the following description of the process flow 400, the operations between the devices 405 may be transmitted in a different order than the order shown, or the operations performed by the devices 405 may be performed in different orders or at different times. Some operations may also be left out of the process flow 400, or other operations may be added to the process flow 400. It is to be understood that while the devices 405 are shown performing a number of the operations of process flow 400, any wireless device may perform the operations shown.

At 410, the device 405-b may activate an independent synchronization source mode based on one or more conditions associated with the device 405-b being satisfied. The independent synchronization source mode may correspond to the device 405-b operating as a reference for synchronization. For example, the one or more conditions may be satisfied based on a deployment scenario of the device 405-b, such as when the device 405-b is an RSU. Additionally, or alternatively, the device 405-b may determine one or more applications supported by the device 405-b, and the one or more conditions may be satisfied based on the one or more applications being supported by the device 405-b.

In some cases, the one or more conditions may be satisfied based on a priority of a packet for transmission by the device 405-b. The device 405-b may determine the priority of the packet and may determine that the one or more conditions are satisfied based on the priority of the packet.

In some examples, the one or more conditions may be satisfied based on the device 405-b monitoring for one or more other synchronization signals and failing to detect any other synchronization signals during the monitoring. For example, the device 405-b may monitor for a second synchronization signal for a time period (e.g., having a randomly selected time duration). If the device 405-b does not detect the second synchronization signal (e.g., or any other synchronization signals) within the time period, the device 405-b may activate the independent synchronization source mode. Put another way, the device 405-b may activate the independent synchronization source mode based on an absence of the second synchronization signal during the monitoring (e.g., within the time period).

At 415, the device 405-b may select one or more bits to include in a synchronization signal. In some examples, the synchronization signal may include multiple synchronization signals, such as multiple SLSSs, a sidelink PSS, a sidelink SSS, a PSBCH, or a combination thereof. The synchronization signal may include a bit field for indicating a coverage status of the device 405-b (e.g., inCoverage), and the device 405-b may select one or more bits for the bit field indicating the coverage status based on a device type (e.g., an RSU, an OBU) associated with the device 405-b and the independent synchronization source mode. The one or more bits may indicate or otherwise correspond to the device type associated with the device 405-b. For example, a bit value of 0 may correspond to an OBU device type, while a bit value of 1 may correspond to an RSU device type. If the device 405-b is an OBU, the device 405-b may select the one or more bits having a bit value of 0 to indicate the OBU device type; if the device 405-b is an RSU, the device 405-b may select the one or more bits having a bit value of 1 to indicate the RSU device type. In some cases, the one or more bits may also indicate that the device 405-b is operating as the reference for synchronization.

Additionally, or alternatively, the synchronization signal may include a sidelink MIB, and the device 405-b may select one or more bits for the sidelink MIB (e.g., one or more reserved bits of the sidelink MIB) based on the device type associated with the device 405-b and the independent synchronization source mode. One or more bits of the sidelink MIB may indicate the device type and may indicate that the device 405-b is operating as the reference for synchronization. For example, the device 405-b may receive an RRC message, a SIB, or the like, indicating one or more bit values to use for the one or more bits that correspond to the device type associated with the device 405-b. In some cases, the device 405-b may be preconfigured with one or more bit values corresponding to the device type.

In some cases, such as when the device 405-b activates the independent synchronization source mode based on the priority of the packet, the device 405-b may select one or more bits for a reserved bit field included in the synchronization signal based on the priority of the packet. For example, the device 405-b may select the one or more bits such that the one or more bits indicate the priority of the packet. Additionally, at least one of the one or more bits may indicate a device priority for the packet, where the device priority may correspond to a device type of a receiving device. The device priority may, for example, correspond to an RSU (e.g., a receiving RSU), an OBU (e.g., a receiving OBU), or both.

At 420, the device 405-b may select a first identifier from a set of identifiers associated with the independent synchronization source mode. The set of identifiers may correspond to the device type associated with the device 405-b. For example, the device 405-b may be an example of an RSU, and may randomly select the first identifier from a set of identifiers corresponding to RSUs. The device 405-b may alternatively be an example of an OBU, and may randomly select the first identifier from a set of identifiers corresponding to OBUs. The device 405-b may generate the synchronization signal based on the first identifier. The first identifier (and the set of identifiers) may be an example of an SLSS ID.

At 425, the device 405-b may transmit, and the device 405-a may receive, one or more synchronization signals, which may include or be examples of SLSSs, PSSs, SSSs, PSBCHs, or the like, among other examples. For instance, a synchronization signal may be an example of an SLSS and may, in some cases, include both a PSS and an SSS. The synchronization signal may indicate the device type associated with the device 405-b and may indicate that the device 405-b is operating as the reference for synchronization. For example, the synchronization signal may be generated based on the SLSS ID corresponding to the device type associated with the device 405-b, e.g., selected at 420. Additionally, or alternatively, based on selecting the one or more bits at 415, the synchronization signal may include a bit field for indicating a coverage status of the device 405-b (e.g., inCoverage), where the one or more bits of the bit field selected at 415 indicate the device type associated with the device 405-b. Additionally, or alternatively, the synchronization signal may include one or more reserved bits, such as one or more bits of a sidelink MIB selected by the device 405-b at 415, that may indicate the device type associated with the device 405-b. In some examples, one or more of the reserved bits may indicate the priority of the packet, such as a device priority of the packet for an RSU, an OBU, or both.

In some examples, the synchronization signal may indicate a priority of the device 405-b. The priority of the device 405-b may indicate or be associated with a priority of the device 405-b acting as an independent synchronization source. Alternatively, the priority of the device 405-b may indicate or be associated with a priority group associated with the device 405-b, e.g., a priority group to which the device 405-b belongs.

At 430, the device 405-c may transmit, and the device 405-a may receive, a second one or more synchronization signals, which may include or be examples of SLSSs, PSSs, SSSs, PSBCHs, or the like, among other examples. For instance, a synchronization signal may be an example of an SLSS and may, in some cases, include both a PSS and an SSS. The device 405-b may also receive the second one or more synchronization signals from the device 405-c. The second synchronization signal(s) may indicate a device type associated with the device 405-c and may indicate that the device 405-c is operating as a second reference for synchronization. For example, the second synchronization signal may be generated based on a second SLSS ID associated with the independent synchronization source mode. The second SLSS ID may be associated with a set of identifiers corresponding to the device type associated with the device 405-c. If the device type associated with the device 405-c and the device type associated with the device 405-b are the same, the first SLSS ID and the second SLSS ID may be associated with a same set of identifiers. Alternatively, the first SLSS ID and the second SLSS ID may each be associated with a respective set of identifiers. For example, the first SLSS ID may be associated with a first set of identifiers corresponding to the device type associated with the device 405-b and the second SLSS ID may be associated with a second set of identifiers corresponding to the device type associated with the device 405-c.

Additionally, or alternatively, the second synchronization signal may include a bit field for indicating a coverage status of the device 405-c (e.g., inCoverage), where the one or more bits of the bit field indicate the device type associated with the device 405-c and indicate that the device 405-c is operating as the second reference for synchronization. Additionally, or alternatively, the second synchronization signal may include one or more reserved bits, such as one or more bits of a sidelink MIB, that may indicate the device type associated with the device 405-c and indicate that the device 405-c is operating as the second reference for synchronization. In some examples, one or more of the reserved bits may indicate a priority of a packet for transmission by the device 405-c, such as a device priority of the packet for an RSU, an OBU, or both.

In some examples, the synchronization signal may indicate a priority of the device 405-c. The priority of the device 405-c may indicate or be associated with a priority of the device 405-c acting as an independent synchronization source. Alternatively, the priority of the device 405-c may indicate or be associated with a priority group associated with the device 405-c, e.g., a priority group to which the device 405-c belongs.

At 435, the device 405-a may determine a first priority of a first packet for transmission by the device 405-b based on the synchronization signal received at 425 (e.g., based on one or more bits included in the synchronization signal received at 425). The device 405-a may also determine a second priority of a second packet for transmission by the device 405-c based on the synchronization signal received at 430 (e.g., based on one or more bits included in the second synchronization signal received at 430). In some cases, the device 405-a may determine a device priority for the first packet, a device priority for the second packet, or both, based on a device type associated with the device 405-a. For example, if the device 405-a is an RSU, the device 405-a may determine a device priority based on an indication (e.g., in the synchronization signal) of the device priority of the packet corresponding to an RSU.

At 440, the device 405-b may determine a device type associated with the device 405-c, e.g., based on an indication included in the second synchronization signal. For example, the device 405-b may determine the device type associated with the device 405-c based on one or more reserved bits (e.g., of a sidelink MIB) corresponding to the device type, one or more bits for a bit field indicating a coverage status of the device 405-c (e.g., inCoverage), the second SLSS ID associated with the second synchronization signal, or a combination thereof.

At 445, the device 405-a may determine a device type associated with the device 405-b, e.g., based on an indication included in the synchronization signal. Additionally, if the device 405-a received the second synchronization signal at 430, the device 405-a may determine a device type associated with the device 405-c, e.g., based on an indication included in the second synchronization signal. For example, the device 405-a may determine the device type associated with the device 405-b based on one or more reserved bits (e.g., of a sidelink MIB) corresponding to the device type and indicated by the synchronization signal, one or more bits for a bit field indicating a coverage status of the device 405-b (e.g., inCoverage) in the synchronization signal, the first SLSS ID associated with the synchronization signal, or a combination thereof. The device 405-a may determine the device type associated with the device 405-c based on one or more reserved bits (e.g., of a sidelink MIB) corresponding to the device type and indicated by the second synchronization signal, one or more bits for a bit field indicating a coverage status of the device 405-c (e.g., inCoverage) in the second synchronization signal, the second SLSS ID associated with the second synchronization signal, or a combination thereof.

In some examples, the device type associated with the device 405-b and the device type associated with the device 405-c may be the same. In other examples, the device type associated with the device 405-b may be different from the device type associated with the device 405-c.

At 450, the device 405-b may compare an identifier of the device 405-c (e.g., corresponding to the device type associated with the device 405-c) and an identifier of the device 405-b (e.g., corresponding to the device type associated with the device 405-b). For example, the device 405-b may compare the first SLSS ID (e.g., selected at 420) and the second SLSS ID (e.g., indicated by the second synchronization signal).

At 455, the device 405-a may compare an identifier of the device 405-c (e.g., indicated in the second synchronization signal) and an identifier of the device 405-b (e.g., indicated in the first synchronization signal). For example, the device 405-a may compare the first SLSS ID (e.g., indicated by the synchronization signal) and the second SLSS ID (e.g., indicated by the second synchronization signal).

At 460, the device 405-b may optionally determine to deactivate the independent synchronization source mode. For example, the device 405-b may deactivate the independent synchronization source mode based on receiving the second synchronization signal at 430. Additionally, or alternatively, the device 405-b may deactivate the independent synchronization source mode based on the device types determined at 440, the comparison of the identifiers at 450, or the like, among other examples.

For example, if the device type associated with the device 405-b and the device type associated with the device 405-c are the same, the device 405-b may compare the first SLSS ID and the second SLSS ID at 450, and may deactivate the independent synchronization source mode based on a rule associated with the comparison. As a specific, non-limiting example, the device 405-b may deactivate the independent synchronization source mode if the second SLSS ID is greater than the first SLSS ID. Alternatively, if the device type associated with the device 405-b and the device type associated with the device 405-c are different, the device 405-b may deactivate the independent synchronization source mode based on the device type of the device 405-c and, in some cases, the device type of the device 405-b. For example, if the device 405-b is an OSU, the device 405-b may deactivate the independent synchronization source mode based on the device 405-c being an RSU.

In some cases, the device 405-b may, at 460, refrain from deactivating the independent synchronization source mode based on the device type associated with the device 405-b and, in some examples, the device type associated with the device 405-c. For instance, if the device 405-b is an RSU, the device 405-b may refrain from deactivating the independent synchronization source mode based on the device 405-c being an OBU.

At 465, the device 405-a may select the device 405-c as a reference for synchronization, for example, based on the second synchronization signal received at 430, the packet priority determined at 435, the identifiers compared at 455, the device type determined at 445, or the like, among other examples. For instance, the device 405-a may select the device 405-c as the reference for synchronization based on the second SLSS ID, the one or more bits of the sidelink MIB transmitted as part of the second synchronization signal, the one or more bits for the bit field indicating the coverage status of the device 405-c, the priority of the packet to be transmitted by the device 405-c, etc. In some cases, the device 405-a may select the device 405-c as a reference for synchronization based on the device type associated with the device 405-c and, in some examples, a device type associated with the device 405-a. Additionally, or alternatively, the device 405-a may select the device 405-c based on an indication of a priority of the device 405-c and an indication of a priority of the device 405-b. For example, the device 405-a may select the device 405-c if the corresponding priority is relatively higher than the priority corresponding to the device 405-b.

In some cases, the device 405-a may select the device 405-c as the reference for synchronization based on a deployment type of the device 405-a, one or more applications supported by the device 405-a, or a combination thereof, among other examples.

At 470, the device 405-a may synchronize with the device 405-c based on the second synchronization signal.

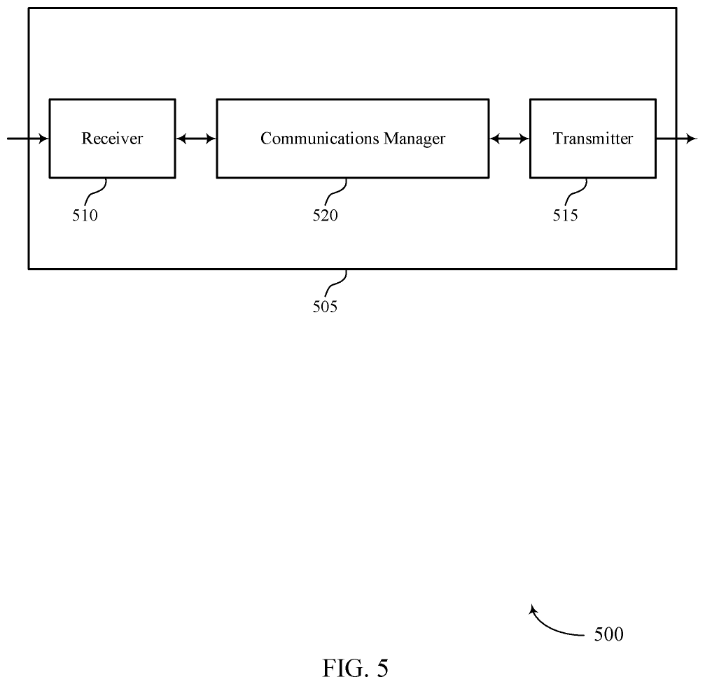

FIG. 5 shows a block diagram 500 of a device 505 that supports source based synchronization for wireless devices in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to source based synchronization for wireless devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to source based synchronization for wireless devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of source based synchronization for wireless devices as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first wireless device in accordance with examples as disclosed herein. For example, the communications manager 520 may be configured as or otherwise support a means for activating an independent synchronization source mode for the first wireless device based on one or more conditions associated with the first wireless device being satisfied, where the independent synchronization source mode corresponds to the first wireless device operating as a reference for synchronization. The communications manager 520 may be configured as or otherwise support a means for transmitting, by the first wireless device operating in the independent synchronization source mode, one or more synchronization signals indicating a device type associated with the first wireless device and indicating that the first wireless device is operating as the reference for synchronization.

Additionally, or alternatively, the communications manager 520 may support wireless communications at a second wireless device in accordance with examples as disclosed herein. For example, the communications manager 520 may be configured as or otherwise support a means for receiving, from a first wireless device, one or more synchronization signals indicating a device type associated with the first wireless device and indicating that the first wireless device is operating as a reference for synchronization. The communications manager 520 may be configured as or otherwise support a means for selecting the first wireless device as the reference for synchronization based on the one or more synchronization signals and the device type. The communications manager 520 may be configured as or otherwise support a means for synchronizing with the first wireless device based on the selecting.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for source-based synchronization. For example, the device 505 may operate as an independent synchronization source and may transmit one or more synchronization signals that indicate a device type of the device 505 and indicate that the device 505 is operating as a reference for synchronization. The device 505 may dynamically activate or deactivate the independent synchronization source mode in accordance with the techniques described herein, which may reduce power consumption and improve overall performance at the device 505. Alternatively, the device 505 may operate as a receiving device that may select an independent synchronization source based on a device type of the independent synchronization source, which may improve communications efficiency, reduce collisions and congestion, and improve resource utilization efficiency, among other examples.

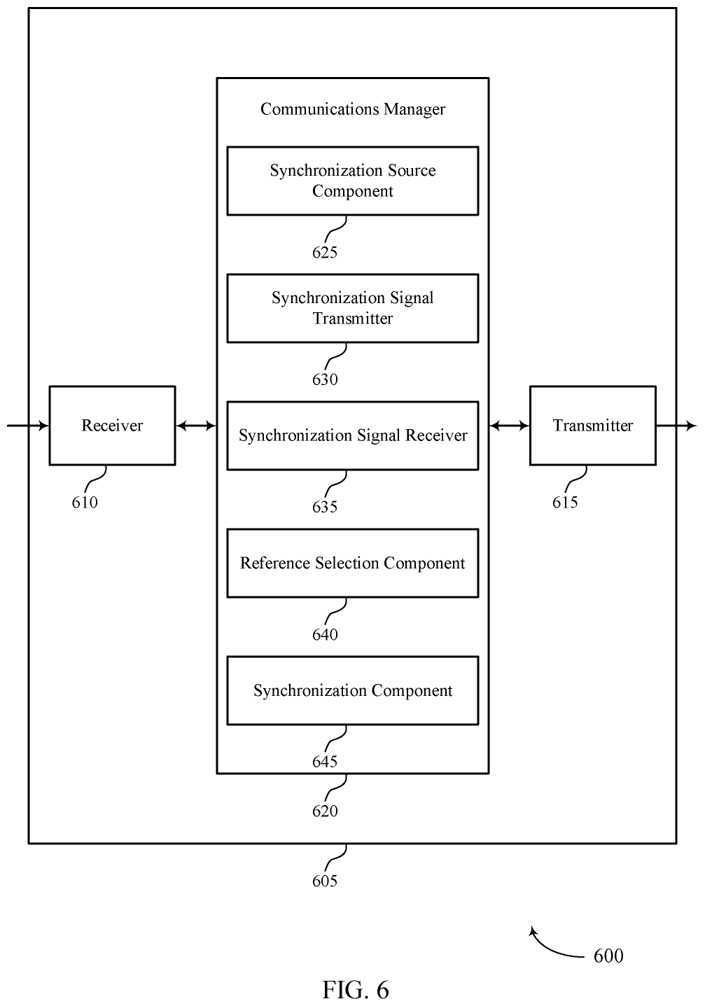

FIG. 6 shows a block diagram 600 of a device 605 that supports source based synchronization for wireless devices in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to source based synchronization for wireless devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to source based synchronization for wireless devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of source based synchronization for wireless devices as described herein. For example, the communications manager 620 may include a synchronization source component 625, a synchronization signal transmitter 630, a synchronization signal receiver 635, a reference selection component 640, a synchronization component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first wireless device in accordance with examples as disclosed herein. The synchronization source component 625 may be configured as or otherwise support a means for activating an independent synchronization source mode for the first wireless device based on one or more conditions associated with the first wireless device being satisfied, where the independent synchronization source mode corresponds to the first wireless device operating as a reference for synchronization. The synchronization signal transmitter 630 may be configured as or otherwise support a means for transmitting, by the first wireless device operating in the independent synchronization source mode, one or more synchronization signals indicating a device type associated with the first wireless device and indicating that the first wireless device is operating as the reference for synchronization.

Additionally, or alternatively, the communications manager 620 may support wireless communications at a second wireless device in accordance with examples as disclosed herein. The synchronization signal receiver 635 may be configured as or otherwise support a means for receiving, from a first wireless device, one or more synchronization signals indicating a device type associated with the first wireless device and indicating that the first wireless device is operating as a reference for synchronization. The reference selection component 640 may be configured as or otherwise support a means for selecting the first wireless device as the reference for synchronization based on the one or more synchronization signals and the device type. The synchronization component 645 may be configured as or otherwise support a means for synchronizing with the first wireless device based on the selecting.

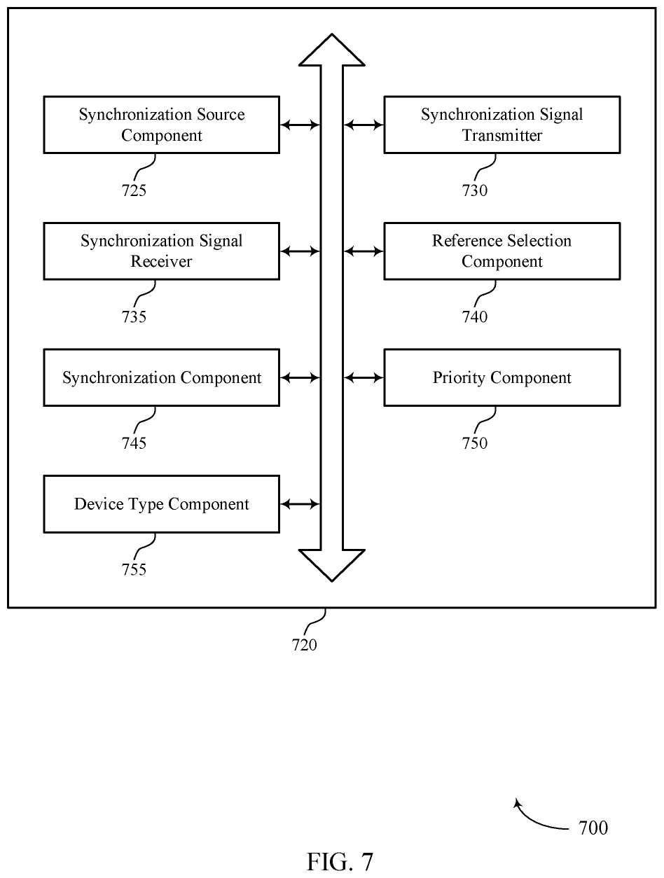

FIG. 7 shows a block diagram 700 of a communications manager 720 that supports source based synchronization for wireless devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of source based synchronization for wireless devices as described herein. For example, the communications manager 720 may include a synchronization source component 725, a synchronization signal transmitter 730, a synchronization signal receiver 735, a reference selection component 740, a synchronization component 745, a priority component 750, a device type component 755, or any combination thereof. Each of these components may communicate, directly or indirectly, with one another (e.g., via one or more buses).

The communications manager 720 may support wireless communications at a first wireless device in accordance with examples as disclosed herein. The synchronization source component 725 may be configured as or otherwise support a means for activating an independent synchronization source mode for the first wireless device based on one or more conditions associated with the first wireless device being satisfied, where the independent synchronization source mode corresponds to the first wireless device operating as a reference for synchronization. The synchronization signal transmitter 730 may be configured as or otherwise support a means for transmitting, by the first wireless device operating in the independent synchronization source mode, one or more synchronization signals indicating a device type associated with the first wireless device and indicating that the first wireless device is operating as the reference for synchronization.

In some examples, to support transmitting the one or more synchronization signals, the priority component 750 may be configured as or otherwise support a means for transmitting an indication of a priority of the first wireless device, the priority indicating the first wireless device acting as an independent synchronization source or indicating a priority group associated with the first wireless device.

In some examples, the one or more synchronization signals include a bit field indicating a coverage status of the first wireless device, and the device type component 755 may be configured as or otherwise support a means for selecting one or more bits for the bit field indicating the coverage status based on the device type associated with the first wireless device and the independent synchronization source mode, where the one or more bits indicate the device type associated with the first wireless device and indicate that the first wireless device is operating as the reference for synchronization.

In some examples, the one or more synchronization signals include a sidelink MIB, and the device type component 755 may be configured as or otherwise support a means for selecting one or more bits for the sidelink MIB based on the device type associated with the first wireless device and the independent synchronization source mode, where the one or more bits indicate the device type associated with the first wireless device and indicate that the first wireless device is operating as the reference for synchronization.

In some examples, the device type component 755 may be configured as or otherwise support a means for selecting a first identifier from a set of identifiers associated with the independent synchronization source mode, where the set of identifiers corresponds to the device type associated with the first wireless device. In some examples, the synchronization signal transmitter 730 may be configured as or otherwise support a means for generating the one or more synchronization signals based on the first identifier.

In some examples, the synchronization signal receiver 735 may be configured as or otherwise support a means for receiving a second one or more synchronization signals indicating a device type associated with a second wireless device. In some examples, the synchronization source component 725 may be configured as or otherwise support a means for deactivating the independent synchronization source mode for the first wireless device based on receiving the second one or more synchronization signals.

In some examples, the device type associated with the first wireless device and the device type associated with the second wireless device are a same device type, and the synchronization signal receiver 735 may be configured as or otherwise support a means for receiving, as part of the second one or more synchronization signals, a second identifier corresponding to the device type associated with the second wireless device, where deactivating the independent synchronization source mode for the first wireless device is based on a comparison of the first identifier and the second identifier.

In some examples, the device type associated with the first wireless device is different from the device type associated with the second wireless device, and the synchronization signal receiver 735 may be configured as or otherwise support a means for receiving, as part of the second one or more synchronization signals, a second identifier corresponding to the device type associated with the second wireless device, where deactivating the independent synchronization source mode for the first wireless device is based on the device type associated with the second wireless device.

In some examples, the one or more conditions associated with the first wireless device are satisfied based on a deployment scenario of the first wireless device. In some examples, the first wireless device is a RSU.

In some examples, the synchronization source component 725 may be configured as or otherwise support a means for determining one or more applications supported by the first wireless device, where the one or more conditions associated with the first wireless device are satisfied based on the one or more applications.

In some examples, the synchronization source component 725 may be configured as or otherwise support a means for determining that the one or more conditions associated with the first wireless device are satisfied based on a priority of a packet for transmission by the first wireless device. In some examples, the one or more synchronization signals include a reserved bit field, and the synchronization source component 725 may be configured as or otherwise support a means for selecting one or more bits for the reserved bit field based on the priority of the packet, where the one or more bits indicate the priority of the packet. In some examples, at least one of the one or more bits indicates a device priority for the packet, the device priority corresponding to one or both of a RSU and an OBU.

In some examples, the synchronization signal receiver 735 may be configured as or otherwise support a means for monitoring, within a time period, for a second one or more synchronization signals from a second wireless device, where activating the independent synchronization source mode is based on an absence of the second one or more synchronization signals during the monitoring within the time period.

In some examples, the one or more synchronization signals include an SLSS. In some examples, a first device type corresponds to a RSU and a second device type corresponds to an OBU.

Additionally, or alternatively, the communications manager 720 may support wireless communications at a second wireless device in accordance with examples as disclosed herein. The synchronization signal receiver 735 may be configured as or otherwise support a means for receiving, from a first wireless device, one or more synchronization signals indicating a device type associated with the first wireless device and indicating that the first wireless device is operating as a reference for synchronization. The reference selection component 740 may be configured as or otherwise support a means for selecting the first wireless device as the reference for synchronization based on the one or more synchronization signals and the device type. The synchronization component 745 may be configured as or otherwise support a means for synchronizing with the first wireless device based on the selecting.

In some examples, the synchronization component 745 may be configured as or otherwise support a means for transmitting one or more synchronization signals indicating that a timing of the second wireless device is based on the first wireless device being the reference for synchronization for the second wireless device.

In some examples, the reference selection component 740 may be configured as or otherwise support a means for receiving, as part of the one or more synchronization signals, a bit field indicating a coverage status of the first wireless device, where one or more bits for the bit field indicate the device type associated with the first wireless device and indicate that the first wireless device is operating as the reference for synchronization, and where selecting the first wireless device as the reference for synchronization is based on the one or more bits.

In some examples, the reference selection component 740 may be configured as or otherwise support a means for receiving, as part of the one or more synchronization signals, a sidelink MIB, where one or more bits for the sidelink MIB indicate the device type associated with the first wireless device and indicate that the first wireless device is operating as the reference for synchronization, and where selecting the first wireless device as the reference for synchronization is based on the one or more bits.

In some examples, the reference selection component 740 may be configured as or otherwise support a means for receiving, as part of the one or more synchronization signals, a first identifier from a set of identifiers associated with an independent synchronization source mode, where the set of identifiers corresponds to the device type associated with the first wireless device, and where selecting the first wireless device as the reference for synchronization is based on the first identifier.

In some examples, the synchronization signal receiver 735 may be configured as or otherwise support a means for receiving a second one or more synchronization signals indicating a device type associated with a third wireless device and indicating that the third wireless device is operating as a second reference for synchronization, where the second one or more synchronization signals include a second identifier from the set of identifiers associated with the independent synchronization source mode and corresponding to the device type associated with the third wireless device, where selecting the first wireless device as the reference for synchronization is based on a comparison of the first identifier and the second identifier.

In some examples, the device type associated with the first wireless device and the device type associated with the third wireless device are a same device type.

In some examples, to support selecting the first wireless device as the reference for synchronization, the reference selection component 740 may be configured as or otherwise support a means for selecting the first wireless device based on a deployment scenario of the second wireless device, one or more applications supported by the second wireless device, or a combination thereof.

In some examples, selecting the first wireless device as the reference for synchronization is based on the device type associated with the first wireless device and the device type associated with the second wireless device.

In some examples, the priority component 750 may be configured as or otherwise support a means for receiving, as part of the one or more synchronization signals, a reserved bit field, where one or more bits for the reserved bit field indicate a priority of a packet for transmission by the first wireless device, and where selecting the first wireless device as the reference for synchronization is based on the priority of the packet.

In some examples, at least one of the one or more bits indicates a device priority for the packet, the device priority corresponding to one or both of a RSU and an OBU. In some examples, selecting the first wireless device as the reference for synchronization is based on the device priority.

In some examples, the one or more synchronization signals include an SLSS. In some examples, a first device type corresponds to a RSU and a second device type corresponds to an OBU.

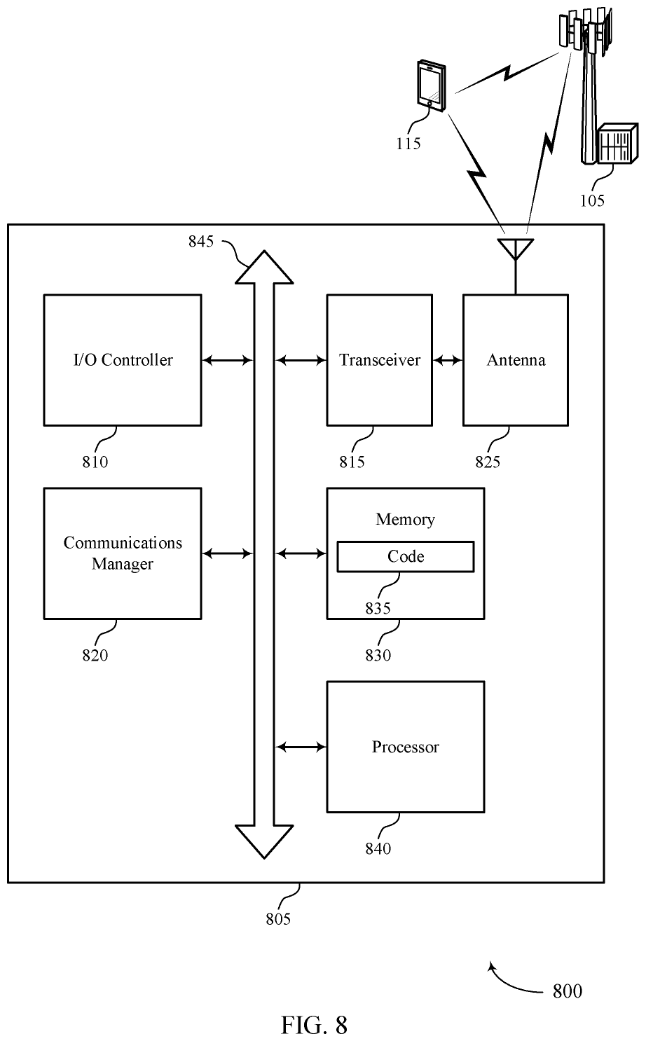

FIG. 8 shows a diagram of a system 800 including a device 805 that supports source based synchronization for wireless devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting source based synchronization for wireless devices). For example, the device 805 or a component of the device 805 may include a processor 840 and memory 830 coupled with or to the processor 840, the processor 840 and memory 830 configured to perform various functions described herein.

The communications manager 820 may support wireless communications at a first wireless device in accordance with examples as disclosed herein. For example, the communications manager 820 may be configured as or otherwise support a means for activating an independent synchronization source mode for the first wireless device based on one or more conditions associated with the first wireless device being satisfied, where the independent synchronization source mode corresponds to the first wireless device operating as a reference for synchronization. The communications manager 820 may be configured as or otherwise support a means for transmitting, by the first wireless device operating in the independent synchronization source mode, one or more synchronization signals indicating a device type associated with the first wireless device and indicating that the first wireless device is operating as the reference for synchronization.

Additionally, or alternatively, the communications manager 820 may support wireless communications at a second wireless device in accordance with examples as disclosed herein. For example, the communications manager 820 may be configured as or otherwise support a means for receiving, from a first wireless device, one or more synchronization signals indicating a device type associated with the first wireless device and indicating that the first wireless device is operating as a reference for synchronization. The communications manager 820 may be configured as or otherwise support a means for selecting the first wireless device as the reference for synchronization based on the one or more synchronization signals and the device type. The communications manager 820 may be configured as or otherwise support a means for synchronizing with the first wireless device based on the selecting.

By including or configuring the communications manager 820 in accordance with examples as described herein, the device 805 may support techniques for source-based synchronization. For example, the device 805 may operate as an independent synchronization source and may transmit one or more synchronization signals that indicate a device type of the device 805 and indicate that the device 805 is operating as a reference for synchronization. The device 805 may dynamically activate or deactivate the independent synchronization source mode in accordance with the techniques described herein, which may improve coordination between devices, increase communications reliability, and reduce latency. Alternatively, the device 805 may operate as a receiving device that may select an independent synchronization source based on a device type of the independent synchronization source, which may improve coordination between devices, increase communications reliability, and reduce power consumption.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of source based synchronization for wireless devices as described herein, or the processor 840 and the memory 830 may be otherwise configured to perform or support such operations.

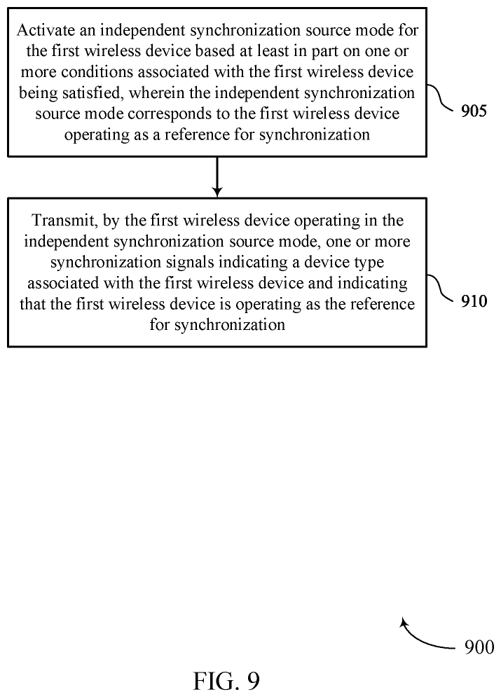

FIG. 9 shows a flowchart illustrating a method 900 that supports source based synchronization for wireless devices in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include activating an independent synchronization source mode for the first wireless device based on one or more conditions associated with the first wireless device being satisfied, where the independent synchronization source mode corresponds to the first wireless device operating as a reference for synchronization. The operations of 905 may be performed in accordance with examples as disclosed herein. In some examples, aspects of the operations of 905 may be performed by a synchronization source component 725 as described with reference to FIG. 7.

At 910, the method may include transmitting, by the first wireless device operating in the independent synchronization source mode, one or more synchronization signals indicating a device type associated with the first wireless device and indicating that the first wireless device is operating as the reference for synchronization. The operations of 910 may be performed in accordance with examples as disclosed herein. In some examples, aspects of the operations of 910 may be performed by a synchronization signal transmitter 730 as described with reference to FIG. 7.

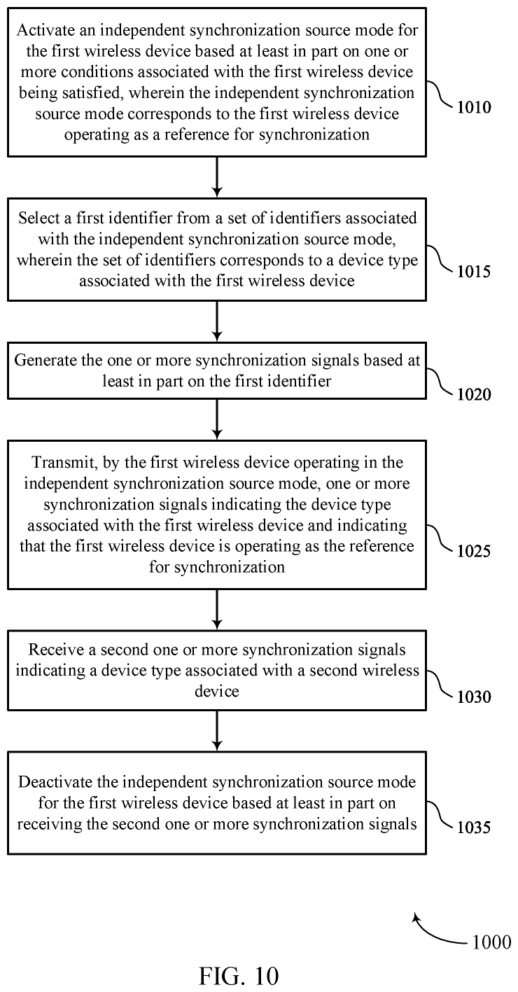

FIG. 10 shows a flowchart illustrating a method 1000 that supports source based synchronization for wireless devices in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1010, the method may include activating an independent synchronization source mode for the first wireless device based on one or more conditions associated with the first wireless device being satisfied, where the independent synchronization source mode corresponds to the first wireless device operating as a reference for synchronization. The operations of 1010 may be performed in accordance with examples as disclosed herein. In some examples, aspects of the operations of 1010 may be performed by a synchronization source component 725 as described with reference to FIG. 7.

At 1015, the method may include selecting a first identifier from a set of identifiers associated with the independent synchronization source mode, where the set of identifiers corresponds to the device type associated with the first wireless device. The operations of 1015 may be performed in accordance with examples as disclosed herein. In some examples, aspects of the operations of 1015 may be performed by a device type component 755 as described with reference to FIG. 7.

At 1020, the method may include generating the one or more synchronization signals based on the first identifier. The operations of 1020 may be performed in accordance with examples as disclosed herein. In some examples, aspects of the operations of 1020 may be performed by a synchronization signal transmitter 730 as described with reference to FIG. 7.

At 1025, the method may include transmitting, by the first wireless device operating in the independent synchronization source mode, one or more synchronization signals indicating a device type associated with the first wireless device and indicating that the first wireless device is operating as the reference for synchronization. The operations of 1025 may be performed in accordance with examples as disclosed herein. In some examples, aspects of the operations of 1025 may be performed by a synchronization signal transmitter 730 as described with reference to FIG. 7.

At 1030, the method may include receiving a second one or more synchronization signals indicating a device type associated with a second wireless device. The operations of 1030 may be performed in accordance with examples as disclosed herein. In some examples, aspects of the operations of 1030 may be performed by a synchronization signal receiver 735 as described with reference to FIG. 7.

At 1035, the method may include deactivating the independent synchronization source mode for the first wireless device based on receiving the second one or more synchronization signals. The operations of 1035 may be performed in accordance with examples as disclosed herein. In some examples, aspects of the operations of 1035 may be performed by a synchronization source component 725 as described with reference to FIG. 7.

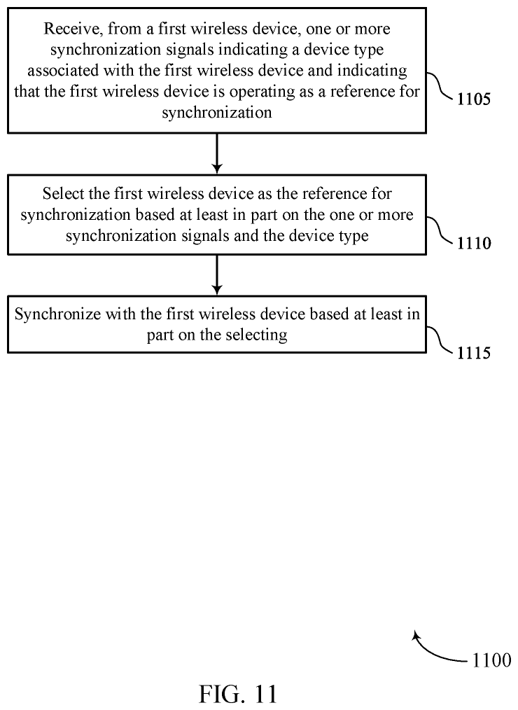

FIG. 11 shows a flowchart illustrating a method 1100 that supports source based synchronization for wireless devices in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, from a first wireless device, one or more synchronization signals indicating a device type associated with the first wireless device and indicating that the first wireless device is operating as a reference for synchronization. The operations of 1105 may be performed in accordance with examples as disclosed herein. In some examples, aspects of the operations of 1105 may be performed by a synchronization signal receiver 735 as described with reference to FIG. 7.

At 1110, the method may include selecting the first wireless device as the reference for synchronization based on the one or more synchronization signals and the device type. The operations of 1110 may be performed in accordance with examples as disclosed herein. In some examples, aspects of the operations of 1110 may be performed by a reference selection component 740 as described with reference to FIG. 7.

At 1115, the method may include synchronizing with the first wireless device based on the selecting. The operations of 1115 may be performed in accordance with examples as disclosed herein. In some examples, aspects of the operations of 1115 may be performed by a synchronization component 745 as described with reference to FIG. 7.

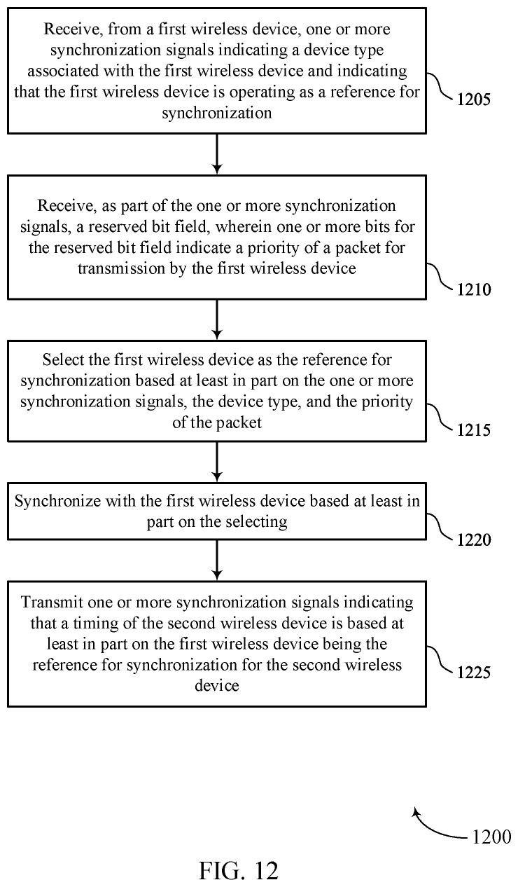

FIG. 12 shows a flowchart illustrating a method 1200 that supports source based synchronization for wireless devices in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include receiving, from a first wireless device, one or more synchronization signals indicating a device type associated with the first wireless device and indicating that the first wireless device is operating as a reference for synchronization. The operations of 1205 may be performed in accordance with examples as disclosed herein. In some examples, aspects of the operations of 1205 may be performed by a synchronization signal receiver 735 as described with reference to FIG. 7.

At 1210, the method may include receiving, as part of the one or more synchronization signals, a reserved bit field, where one or more bits for the reserved bit field indicate a priority of a packet for transmission by the first wireless device. The operations of 1210 may be performed in accordance with examples as disclosed herein. In some examples, aspects of the operations of 1210 may be performed by a priority component 750 as described with reference to FIG. 7.

At 1215, the method may include selecting the first wireless device as the reference for synchronization based on the one or more synchronization signals, the device type, and the priority of the packet. The operations of 1215 may be performed in accordance with examples as disclosed herein. In some examples, aspects of the operations of 1215 may be performed by a reference selection component 740 as described with reference to FIG. 7.

At 1220, the method may include synchronizing with the first wireless device based on the selecting. The operations of 1220 may be performed in accordance with examples as disclosed herein. In some examples, aspects of the operations of 1220 may be performed by a synchronization component 745 as described with reference to FIG. 7.

At 1225, the method may include transmitting one or more synchronization signals indicating that a timing of the second wireless device is based on the first wireless device being the reference for synchronization for the second wireless device. The operations of 1225 may be performed in accordance with examples as disclosed herein. In some examples, aspects of the operations of 1225 may be performed by a synchronization component 745 as described with reference to FIG. 7.

The following provides an overview of aspects of the present disclosure:

Aspect 1: A method for wireless communications at a first wireless device, comprising: activating an independent synchronization source mode for the first wireless device based at least in part on one or more conditions associated with the first wireless device being satisfied, wherein the independent synchronization source mode corresponds to the first wireless device operating as a reference for synchronization; and transmitting, by the first wireless device operating in the independent synchronization source mode, one or more synchronization signals indicating a device type associated with the first wireless device and indicating that the first wireless device is operating as the reference for synchronization.

Aspect 2: The method of aspect 1, wherein transmitting the one or more synchronization signals comprises: transmitting an indication of a priority of the first wireless device, the priority indicating the first wireless device acting as an independent synchronization source or indicating a priority group associated with the first wireless device.

Aspect 3: The method of any of aspects 1 through 2, wherein the one or more synchronization signals include a bit field indicating a coverage status of the first wireless device, the method further comprising: selecting one or more bits for the bit field indicating the coverage status based at least in part on the device type associated with the first wireless device and the independent synchronization source mode, wherein the one or more bits indicate the device type associated with the first wireless device and indicate that the first wireless device is operating as the reference for synchronization.

Aspect 4: The method of any of aspects 1 through 3, wherein the one or more synchronization signals include a sidelink MIB, the method further comprising: selecting one or more bits for the sidelink MIB based at least in part on the device type associated with the first wireless device and the independent synchronization source mode, wherein the one or more bits indicate the device type associated with the first wireless device and indicate that the first wireless device is operating as the reference for synchronization.

Aspect 5: The method of any of aspects 1 through 4, further comprising: selecting a first identifier from a set of identifiers associated with the independent synchronization source mode, wherein the set of identifiers corresponds to the device type associated with the first wireless device; and generating the one or more synchronization signals based at least in part on the first identifier.

Aspect 6: The method of aspect 5, further comprising: receiving a second one or more synchronization signals indicating a device type associated with a second wireless device; and deactivating the independent synchronization source mode for the first wireless device based at least in part on receiving the second one or more synchronization signals.

Aspect 7: The method of aspect 6, wherein the device type associated with the first wireless device and the device type associated with the second wireless device are a same device type, the method further comprising: receiving, as part of the second one or more synchronization signals, a second identifier corresponding to the device type associated with the second wireless device, wherein deactivating the independent synchronization source mode for the first wireless device is based at least in part on a comparison of the first identifier and the second identifier.

Aspect 8: The method of any of aspects 6 through 7, wherein the device type associated with the first wireless device is different from the device type associated with the second wireless device, the method further comprising: receiving, as part of the second one or more synchronization signals, a second identifier corresponding to the device type associated with the second wireless device, wherein deactivating the independent synchronization source mode for the first wireless device is based at least in part on the device type associated with the second wireless device.

Aspect 9: The method of any of aspects 1 through 8, wherein the one or more conditions associated with the first wireless device are satisfied based at least in part on a deployment scenario of the first wireless device.

Aspect 10: The method of aspect 9, wherein the first wireless device is an RSU.

Aspect 11: The method of any of aspects 1 through 10, further comprising: determining one or more applications supported by the first wireless device, wherein the one or more conditions associated with the first wireless device are satisfied based at least in part on the one or more applications.

Aspect 12: The method of any of aspects 1 through 11, further comprising: determining that the one or more conditions associated with the first wireless device are satisfied based at least in part on a priority of a packet for transmission by the first wireless device.

Aspect 13: The method of aspect 12, wherein the one or more synchronization signals include a reserved bit field, the method further comprising: selecting one or more bits for the reserved bit field based at least in part on the priority of the packet, wherein the one or more bits indicate the priority of the packet.

Aspect 14: The method of aspect 13, wherein at least one of the one or more bits indicates a device priority for the packet, the device priority corresponding to one or both of an RSU and an OBU.

Aspect 15: The method of any of aspects 1 through 14, further comprising: monitoring, within a time period, for a second one or more synchronization signals from a second wireless device, wherein activating the independent synchronization source mode is based at least in part on an absence of the second one or more synchronization signals during the monitoring within the time period.

Aspect 16: The method of any of aspects 1 through 15, wherein the one or more synchronization signals comprise an SLSS.

Aspect 17: The method of any of aspects 1 through 16, wherein a first device type corresponds to an RSU and a second device type corresponds to an OBU.

Aspect 18: A method for wireless communications at a second wireless device, comprising: receiving, from a first wireless device, one or more synchronization signals indicating a device type associated with the first wireless device and indicating that the first wireless device is operating as a reference for synchronization; selecting the first wireless device as the reference for synchronization based at least in part on the one or more synchronization signals and the device type; and synchronizing with the first wireless device based at least in part on the selecting.

Aspect 19: The method of aspect 18, further comprising: transmitting one or more synchronization signals indicating that a timing of the second wireless device is based at least in part on the first wireless device being the reference for synchronization for the second wireless device.

Aspect 20: The method of any of aspects 18 through 19, further comprising: receiving, as part of the one or more synchronization signals, a bit field indicating a coverage status of the first wireless device, wherein one or more bits for the bit field indicate the device type associated with the first wireless device and indicate that the first wireless device is operating as the reference for synchronization, and wherein selecting the first wireless device as the reference for synchronization is based at least in part on the one or more bits.

Aspect 21: The method of any of aspects 18 through 20, further comprising: receiving, as part of the one or more synchronization signals, a sidelink MIB, wherein one or more bits for the sidelink MIB indicate the device type associated with the first wireless device and indicate that the first wireless device is operating as the reference for synchronization, and wherein selecting the first wireless device as the reference for synchronization is based at least in part on the one or more bits.

Aspect 22: The method of any of aspects 18 through 21, further comprising: receiving, as part of the one or more synchronization signals, a first identifier from a set of identifiers associated with an independent synchronization source mode, wherein the set of identifiers corresponds to the device type associated with the first wireless device, and wherein selecting the first wireless device as the reference for synchronization is based at least in part on the first identifier.

Aspect 23: The method of aspect 22, further comprising: receiving a second one or more synchronization signals indicating a device type associated with a third wireless device and indicating that the third wireless device is operating as a second reference for synchronization, wherein the second one or more synchronization signals include a second identifier from the set of identifiers associated with the independent synchronization source mode and corresponding to the device type associated with the third wireless device, wherein selecting the first wireless device as the reference for synchronization is based at least in part on a comparison of the first identifier and the second identifier.

Aspect 24: The method of aspect 23, wherein the device type associated with the first wireless device and the device type associated with the third wireless device are a same device type.

Aspect 25: The method of any of aspects 18 through 24, wherein selecting the first wireless device as the reference for synchronization comprises: selecting the first wireless device based at least in part on a deployment scenario of the second wireless device, one or more applications supported by the second wireless device, or a combination thereof.

Aspect 26: The method of any of aspects 18 through 25, wherein selecting the first wireless device as the reference for synchronization is based at least in part on the device type associated with the first wireless device and the device type associated with the second wireless device.

Aspect 27: The method of any of aspects 18 through 26, further comprising: receiving, as part of the one or more synchronization signals, a reserved bit field, wherein one or more bits for the reserved bit field indicate a priority of a packet for transmission by the first wireless device, and wherein selecting the first wireless device as the reference for synchronization is based at least in part on the priority of the packet.

Aspect 28: The method of aspect 27, wherein at least one of the one or more bits indicates a device priority for the packet, the device priority corresponding to one or both of an RSU and an OBU, and selecting the first wireless device as the reference for synchronization is based at least in part on the device priority.

Aspect 29: The method of any of aspects 18 through 28, wherein the one or more synchronization signals comprise an SLSS.

Aspect 30: The method of any of aspects 18 through 29, wherein a first device type corresponds to an RSU and a second device type corresponds to an OBU.

Aspect 31: An apparatus for wireless communications at a first wireless device, comprising a processor; memory coupled with the processor; and instructions stored in the memory and executable by the processor to cause the apparatus to perform a method of any of aspects 1 through 17.

Aspect 32: An apparatus for wireless communications at a first wireless device, comprising at least one means for performing a method of any of aspects 1 through 17.

Aspect 33: A non-transitory computer-readable medium storing code for wireless communications at a first wireless device, the code comprising instructions executable by a processor to perform a method of any of aspects 1 through 17.

Aspect 34: An apparatus for wireless communications at a second wireless device, comprising a processor; memory coupled with the processor; and instructions stored in the memory and executable by the processor to cause the apparatus to perform a method of any of aspects 18 through 30.

Aspect 35: An apparatus for wireless communications at a second wireless device, comprising at least one means for performing a method of any of aspects 18 through 30.

Aspect 36: A non-transitory computer-readable medium storing code for wireless communications at a second wireless device, the code comprising instructions executable by a processor to perform a method of any of aspects 18 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a first wireless device, comprising:
activating an independent synchronization source mode for the first wireless device based at least in part on one or more conditions associated with the first wireless device being satisfied, wherein the independent synchronization source mode corresponds to the first wireless device operating as a reference for synchronization; and
transmitting, by the first wireless device operating in the independent synchronization source mode, one or more synchronization signals indicating a device type associated with the first wireless device and indicating that the first wireless device is operating as the reference for synchronization.

2. The method of claim 1, wherein transmitting the one or more synchronization signals comprises:
transmitting an indication of a priority of the first wireless device, the priority indicating the first wireless device acting as an independent synchronization source or indicating a priority group associated with the first wireless device.

3. The method of claim 1, wherein the one or more synchronization signals include a bit field indicating a coverage status of the first wireless device, the method further comprising:
selecting one or more bits for the bit field indicating the coverage status based at least in part on the device type associated with the first wireless device and the independent synchronization source mode, wherein the one or more bits indicate the device type associated with the first wireless device and indicate that the first wireless device is operating as the reference for synchronization.

4. The method of claim 1, wherein the one or more synchronization signals include a sidelink master information block, the method further comprising:
selecting one or more bits for the sidelink master information block based at least in part on the device type associated with the first wireless device and the independent synchronization source mode, wherein the one or more bits indicate the device type associated with the first wireless device and indicate that the first wireless device is operating as the reference for synchronization.

5. The method of claim 1, further comprising:
selecting a first identifier from a set of identifiers associated with the independent synchronization source mode, wherein the set of identifiers corresponds to the device type associated with the first wireless device; and
generating the one or more synchronization signals based at least in part on the first identifier.

6. The method of claim 5, further comprising:
receiving a second one or more synchronization signals indicating a device type associated with a second wireless device; and
deactivating the independent synchronization source mode for the first wireless device based at least in part on receiving the second one or more synchronization signals.

7. The method of claim 6, wherein the device type associated with the first wireless device and the device type associated with the second wireless device are a same device type, the method further comprising:
receiving, as part of the second one or more synchronization signals, a second identifier corresponding to the device type associated with the second wireless device, wherein deactivating the independent synchronization source mode for the first wireless device is based at least in part on a comparison of the first identifier and the second identifier.

8-10. (canceled)

11. The method of claim 1,
wherein the one or more conditions associated with the first wireless device are satisfied based at least in part on one or more applications supported by the first wireless device.

12. The method of claim 1,
wherein the one or more conditions associated with the first wireless device are satisfied based at least in part on a priority of a packet for transmission by the first wireless device.

13-14. (canceled)

15. The method of claim 1, further comprising:
monitoring, within a time period, for a second one or more synchronization signals from a second wireless device, wherein activating the independent synchronization source mode is based at least in part on an absence of the second one or more synchronization signals during the monitoring within the time period.

16-17. (canceled)

18. A method for wireless communications at a second wireless device, comprising:
receiving, from a first wireless device, one or more synchronization signals indicating a device type associated with the first wireless device and indicating that the first wireless device is operating as a reference for synchronization;
selecting the first wireless device as the reference for synchronization based at least in part on the one or more synchronization signals and the device type; and
synchronizing with the first wireless device based at least in part on the selecting.

19. The method of claim 18, further comprising:
transmitting one or more synchronization signals indicating that a timing of the second wireless device is based at least in part on the first wireless device being the reference for synchronization for the second wireless device.

20. The method of claim 18, further comprising:
receiving, as part of the one or more synchronization signals, a bit field indicating a coverage status of the first wireless device, wherein one or more bits for the bit field indicate the device type associated with the first wireless device and indicate that the first wireless device is operating as the reference for synchronization, and wherein selecting the first wireless device as the reference for synchronization is based at least in part on the one or more bits.

21. The method of claim 18, further comprising:
receiving, as part of the one or more synchronization signals, a sidelink master information block, wherein one or more bits for the sidelink master information block indicate the device type associated with the first wireless device and indicate that the first wireless device is operating as the reference for synchronization, and wherein selecting the first wireless device as the reference for synchronization is based at least in part on the one or more bits.

22. The method of claim 18, further comprising:
receiving, as part of the one or more synchronization signals, a first identifier from a set of identifiers associated with an independent synchronization source mode, wherein the set of identifiers corresponds to the device type associated with the first wireless device, and wherein selecting the first wireless device as the reference for synchronization is based at least in part on the first identifier.

23. The method of claim 22, further comprising:
receiving a second one or more synchronization signals indicating a device type associated with a third wireless device and indicating that the third wireless device is operating as a second reference for synchronization, wherein the second one or more synchronization signals include a second identifier from the set of identifiers associated with the independent synchronization source mode and corresponding to the device type associated with the third wireless device, wherein selecting the first wireless device as the reference for synchronization is based at least in part on a comparison of the first identifier and the second identifier.

24. The method of claim 23, wherein the device type associated with the first wireless device and the device type associated with the third wireless device are a same device type.

25. The method of claim 18, wherein selecting the first wireless device as the reference for synchronization comprises:
selecting the first wireless device based at least in part on a deployment scenario of the second wireless device, one or more applications supported by the second wireless device, or a combination thereof.

26. The method of claim 18, wherein selecting the first wireless device as the reference for synchronization is based at least in part on the device type associated with the first wireless device and the device type associated with the second wireless device.

27-30. (canceled)

31. A first wireless device for wireless communication, comprising:
one or more memories storing processor-executable code; and
one or more processors coupled with the one or more memories and individually or collectively operable to execute the code to cause the first wireless device to:
activate an independent synchronization source mode for the first wireless device based at least in part on one or more conditions associated with the first wireless device being satisfied, wherein the independent synchronization source mode corresponds to the first wireless device operating as a reference for synchronization; and
transmit, by the first wireless device operating in the independent synchronization source mode, one or more synchronization signals indicating a device type associated with the first wireless device and indicating that the first wireless device is operating as the reference for synchronization.
